(19) United States
(12) Patent Application Publication
(10) Pub. No.: US 2018/0308062 A1
(43) Pub. Date: Oct. 25, 2018

(54) JOB MATCHING SYSTEM AND PROCESS

(71) Applicant: Douglas Quitmeyer, Austin, TX (US)

(72) Inventor: Douglas Quitmeyer, Austin, TX (US)

(21) Appl. No.: 15/962,744

(22) Filed: Apr. 25, 2018

Related U.S. Application Data
(60) Provisional application No. 62/489,454, filed on Apr. 25, 2017.

(51) Int. Cl. G06Q 10/10

(52) U.S. Cl. CPC G06Q 10/1053

(57) ABSTRACT

A job matching system and process for enabling employers to identify qualified candidates for job positions and candidates to identify qualified job positions is provided. The job matching system can include a computing component and one or more analysis modules for allowing employers to provide job application data related to a job position. The analysis modules can analyze and process the job application data and compare the data to candidate profiles to identify qualified candidates for the job position. The job matching system can further include modules for allowing candidates to provide resume and personality data and analyze and process the data to identify job positions for which the candidate is qualified. The job matching system can further include modules for creating resumes related to job positions based on the provided candidate data. The job matching process can include steps for carrying out the functions of the job matching system.

### CROSS-REFERENCE TO RELATED APPLICATIONS

This Application claims the benefit of U.S. Provisional Patent Application No. 62/489,454, filed on Apr. 25, 2017, to Douglas Quitmeyer, entitled “Military Job Application,” currently pending, the entire disclosure of which is incorporated herein by reference.

### FIELD OF THE INVENTION

The present invention is directed generally to systems and processes for matching employer job positions with qualified candidates. The present invention is also directed generally to systems and processes for matching candidates with qualified job positions.

### BACKGROUND OF THE INVENTION

Employers are in constant need of qualified job candidates for new job positions, and it is often challenging for employers to identify qualified candidates having the abilities, skills and experience for a new job position. Employers often utilize recruiting firms, online job posting websites, or online job candidate databases seeking to identify a pool of candidates for a new job position. In each of these solutions, the employer typically provides a job description and selects keywords to identify requirements for the job position. The employer or a hired recruiting firm then typically manually searches through pools and databases of potential applicants to identify candidates meeting the criteria identified by the employer. However, this process is time consuming, lacks efficiency, and often times fails to identify the most qualified candidates for the job position. In addition, it is often difficult to select standardized keywords and criteria to accurately describe the job position without being too specific so as to miss potentially qualified candidates. Known employee-applicant assessment solutions, such as those offered by IBM Kenexa or Plum, utilize an ipsative assessment process in order to categorize and qualify potential candidates for employers; however, such processes have difficulty assessing employee abilities, skills and experiences across different job types and positions, and therefore can be insufficient at accurately categorizing candidates and identifying quality candidates for job positions.

Similarly, job seekers often utilize job search firms and online job posting websites when searching for new job positions for employment. However, these solutions typically provide pools and databases of job positions categorized by job descriptions and job position requirements criteria. The job seekers must then manually search through these pools and databases of job positions to identify potential jobs to apply for. This process also is time consuming, lacks efficiency, often times makes it difficult for the job seeker to identify qualified job positions, and makes it difficult to search for job positions accurately matching the qualifications of the job seeker without being too specific so as to miss potentially-suitable job positions.

Furthermore, the job position fulfillment and placement solutions described above often fail to match quality candidates with employer-created job positions, and similarly, match job seekers with quality job positions. As a result, jobs positions fulfilled using these solutions typically have high turnover and decrease the long-term value for employers for hiring new candidates as well as the value to job seekers for new job positions.

It is therefore an objective of the present invention to provide a job matching system and process that can match employer-created job positions to qualified candidates and match candidates to employee-created job positions for which they are qualified in an automated and efficient manner and that does not have the deficiencies of the aforementioned the art.

### SUMMARY OF THE INVENTION

The present invention is directed to a job matching system and methods for matching job positions to qualified candidates, matching qualified candidates to job positions, and assisting candidates in identifying job positions and creating resumes tailored to specific job positions and/or job types. The job matching system and methods of the present invention incorporate unique and novel ability matching processes and techniques to accurately match the abilities and skills of a candidate to the abilities and skills required for a job position. The unique matching processes and techniques can provide a great benefit to employers when position job positions by increasing the efficiency in recruiting and hiring of candidates and increasing the long-term value of a hired candidate by reducing the turnover rate of a filled job position due to inadequate candidate-job position matching.

The job matching system can include a networked computing component, such as a server, computer or other device, that includes a processor, a user interface and an application program configured for carryout out one or more sets of programming instructions of the system for matching candidates and job positions. The job matching system can further include one or more databases for storing data utilized in the system, including a candidate database, a job position database, and an abilities matching database. The job matching system can further include one or more modules and sub-modules utilized in connection with the program application and the user interface to analyze data provided by employers relating to a job position and data provided by candidates relating to work experience, education, industry specific information, and abilities. The analysis modules can be utilized to process, parse, validate and match information within the provided data to create candidate profiles with abilities data associated with a candidate and job position profiles with abilities data associated with a job position. The analysis modules can further be utilized to analyze, compare and match abilities data between candidate profiles and job position profiles to identify qualified candidates to job positions.

The job matching methods of the present invention can be configured to carry out the steps and procedures of the job matching system. The job matching method can comprise receiving job application data relating to a job position from an employer. The received data can then be analyzed, parsed, validated, processed, associated and matched to create a job profile containing one or more types of data associated with the job position, including abilities data pertaining to required abilities, skills, tasks and/or competencies related to the job position. The job profile can then be analyzed, compared and matched to candidate profiles to identify qualified candidates for the job position, where the candidates are qualified based on a matching of abilities data between the job position and the candidate, among other types of data. One or more types of reports can then be provided to the employer identifying the qualified candidates and other information relating to the qualifications and abilities of the candidates.

The job matching methods of the present invention can further comprise receiving candidate data relating to resume data, personality data, work experiences, education, industry specific data, and abilities of the candidate. The received data can then be analyzed, parsed, validates, processed, associated and matched to create a candidate profile containing one or more types of data associated with the candidate, including abilities data pertaining to abilities associated with the candidate. The candidate profile can then be analyzed and compared to job profiles to identify job types and positions for which the candidate qualifies and/or is best suited for by matching abilities data in the candidate profile to abilities data in one or more job profiles. One or more different types of reports for the candidate can be generated based on the candidate's profile and identified job positions and types matching step, including a candidate analysis report identifying key abilities, a career assessment report identifying most suitable job positions and types, and a gap analysis report identify needed abilities for specific job positions and job types. The job matching methods of the present invention can further comprise creating a resume for a candidate based on the candidate's profile containing abilities data, personality assessment data and other candidate data. The job matching process can recommend a job type or position based on the candidate profile and/or allow the candidate to select a job position or type. A resume specific tailored to the selected or recommended job position or type can be creating utilizing the candidate profile data, including abilities data, most relevant to the selected or recommended job position or type.

The job matching system and methods of the present invention can also include modules and methods for creating abilities data and associating abilities data with candidate profiles and job profiles, evaluating and matching job positions to candidate profiles, and other processes and techniques relating to job matching between employer-created job positions and potential job candidates.

Other aspects and advantages of the present invention will be apparent from the following detailed description of the preferred embodiments of the accompanying drawing figures.

### DESCRIPTION OF THE SEVERAL VIEWS OF THE DRAWING

In the accompanying drawing, which forms a part of the specification and is to be read in conjunction therewith in which like reference numerals are used to indicate like or similar parts in the various views:

FIG. 1 is a schematic diagram view of a job matching system in accordance with one embodiment of the present invention;

FIG. 2A is a schematic flow chart diagram of a job matching process in accordance with one embodiment of the present invention;

FIG. 2B is a schematic flow chart diagram of a job position creation component of the job matching process of FIG. 2A in accordance with one embodiment of the present invention;

FIG. 2C is a schematic flow chart diagram of a candidate profile creation component of the job matching process of FIG. 2A in accordance with one embodiment of the present invention;

FIG. 2D is a schematic flow chart diagram of a candidate resume creation component of the job matching process of FIG. 2A in accordance with one embodiment of the present invention;

FIG. 3A is a schematic diagram view of an exemplary hardware architecture for a computing component used in connection with a job matching system in accordance with one embodiment of the present invention;

FIG. 3B is a schematic diagram view of an exemplary logical architecture for a client computing component used in connection with a job matching system according to one embodiment of the present invention;

FIG. 3C is a schematic diagram view of a computing component used in connection with a job matching system in accordance with one embodiment of the present invention;

FIG. 4 is a schematic diagram view of an exemplary architecture for a distributed computing network configured for use with a job matching system in accordance with one embodiment of the present invention;

FIG. 5 is a schematic diagram view of an ability matching system configured for use with a job matching system in accordance with one embodiment of the present invention;

FIG. 6 is a schematic diagram view of an ability matching system configured for use with a job matching system in accordance with one embodiment of the present invention;

FIG. 7 is a schematic diagram view of an ability matching system configured for use with a job matching system in accordance with one embodiment of the present invention;

FIG. 8 is a schematic diagram view of an ability creation system and job ability association and evaluation system of the ability matching system of FIG. 5 in accordance with one embodiment of the present invention;

FIG. 9 is a schematic diagram view of an ability matching manager of the ability matching system of FIG. 5 in accordance with one embodiment of the present invention;

FIG. 10 is a schematic flow chart diagram of a method for creating and matching abilities in connection with job positions and candidate profiles in accordance with one embodiment of the present invention;

FIG. 11 is a schematic flow chart diagram of an ability data creation method used in connection with the method of FIG. 10 in accordance with one embodiment of the present invention;

FIG. 12 is a schematic flow chart diagram of a method for setting and receiving task data in connection with the method of FIG. 10 in accordance with one embodiment of the present invention;

FIG. 13 is a schematic flow chart diagram of a method for setting and receiving competency data in connection with the method of FIG. 10 in accordance with one embodiment of the present invention;

FIG. 14 is a schematic flow chart diagram of a method for setting and receiving skills data in connection with the method of FIG. 10 in accordance with one embodiment of the present invention;

FIG. 15 is a schematic flow chart diagram of a method for submission and organization of association data in connection with the method of FIG. 10 in accordance with one embodiment of the present invention;

FIG. 16 is a schematic flow chart diagram of a method for inputting a military job to be parsed to identify a job description in connection with the method of FIG. 10 in accordance with one embodiment of the present invention;

FIG. 17 is a schematic flow chart diagram of a method for parsing a military branch job code in connection with the method of FIG. 10 in accordance with one embodiment of the present invention;

FIG. 18 is a schematic flow chart diagram of a method for parsing specialty jobs data in connection with the method of FIG. 10 in accordance with one embodiment of the present invention;

FIG. 19 is a schematic flow chart diagram of a method for parsing job code data in connection with the method of FIG. 10 in accordance with one embodiment of the present invention;

FIG. 20 is a schematic flow chart diagram of a method for inputting a job description in connection with the method of FIG. 10 in accordance with one embodiment of the present invention;

FIG. 21 is a schematic flow chart diagram of a method for parsing data by machine learning in connection with the method of FIG. 10 in accordance with one embodiment of the present invention;

FIG. 22 is a schematic flow chart diagram of a method for parsing data by a curator in connection with the method of FIG. 10 in accordance with one embodiment of the present invention;

FIG. 23 is a schematic flow chart diagram of a method for parsing data by a job submitter in connection with the method of FIG. 10 in accordance with one embodiment of the present invention;

FIG. 24 is a schematic flow chart diagram of a method for associating education data with a profile and abilities in connection with the method of FIG. 10 in accordance with one embodiment of the present invention;

FIG. 25 is a schematic flow chart diagram of a method for associating military branch job codes with a profile and abilities in connection with the method of FIG. 10 in accordance with one embodiment of the present invention;

FIG. 26 is a schematic flow chart diagram of a method for associating previous candidate work with a profile and abilities in connection with the method of FIG. 10 in accordance with one embodiment of the present invention;

FIG. 27 is a schematic flow chart diagram of a method for querying related job data based on a candidate personality in connection with the method of FIG. 10 in accordance with one embodiment of the present invention;

FIG. 28 is a schematic flow chart diagram of a method for querying abilities data when comparing profile data to desired job data in connection with the method of FIG. 10 in accordance with one embodiment of the present invention;

FIG. 29 is a schematic flow chart diagram of a method for querying related job data based on a profile in connection with the method of FIG. 10 in accordance with one embodiment of the present invention; and

FIGS. 30A-30G are schematic diagrams of a candidate career choice assessment report generated by the job matching system of FIG. 1 and in accordance with the method of FIG. 10 in accordance with one embodiment of the present invention.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures. It will be appreciated that any dimensions included in the drawing figures are simply provided as examples and dimensions other than those provided therein are also within the scope of the invention.

The following detailed description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention is defined by the appended claims and the description is, therefore, not to be taken in a limiting sense and shall not limit the scope of equivalents to which such claims are entitled.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions.

Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step).

Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols.

A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

The present invention is directed to a job matching system and one or more processes for matching job positions to qualified job candidates. In accordance with the several embodiments of the system and processes described herein, employers or job creators (referred to herein as client-employers) are enabled to provide job application data for a job position and job candidates (referred to herein as client-candidates) are enabled to provide job qualification data, and the sets of data can be analyzed and processed in order to match candidates to job applications based on one or more criteria. Similarly, the system and processes of the present invention can facilitate the identification of candidates qualified for a job position of an employer or job creator and facilitate the identification of qualified job positions for job candidates. Accordingly, the system and processes of the present invention can increase employer efficiency in recruiting and hiring of candidates and increase quality of new employees short and long term value. The system and processes can similarly increase the ability of qualified candidates to identify and be matched to job positions. With reference to the following description, it is recognized that client-employers can include not only actual employers and similar job creators, but also recruiters or other entities in the business of identifying candidates for job positions.

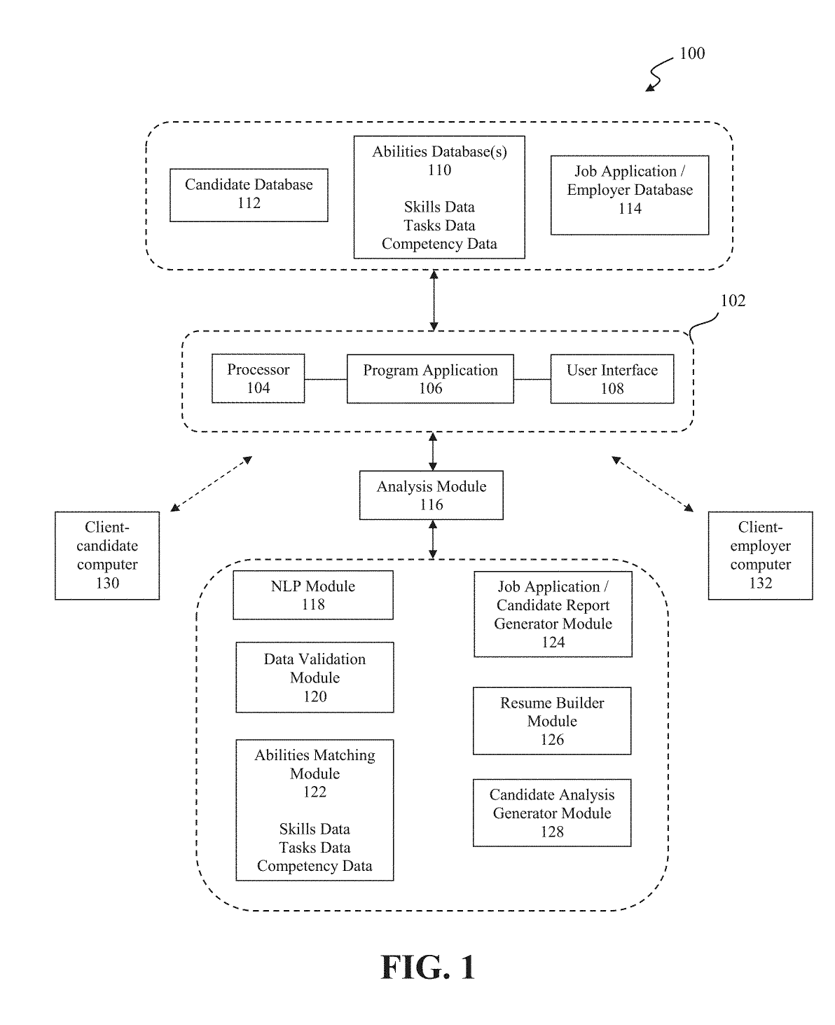

Referring now to FIG. 1, a schematic representation of a job matching system 100 is illustrated in accordance with one embodiment of the present invention. As shown, system 100 can include a networked computing system 102 configured to operate the system 100, communicate with client-candidate computing devices 130 and client-employer computing devices 132 in order to send and receive data and information utilized and/or created by system 100, communicate with one or more data storage servers 110-114, and operate various programs, applications and modules utilized by system 100. Computing system 102 may be configured as any suitable computer system and may include a processing component 104, a program application 106 and a user interface 108. Processing component 104 may be can be any suitable type of computer processor configured for carrying out one or more sets of programming instructions and sending, receiving, processing and/or storing various types of data and information. Program application 106 may be an application with programming instructions, that when executed by processing component 104, cause the system 10 carry out one or more steps and/or procedures for sending, receiving, processing and/or storing various types of data described in greater detail below and instructing the operation of the one or modules and submodules of system 100. Networked computing system 102 may additionally include one or more user interfaces 108 that are operated by program application 106 and enable interaction with client computer devices 130 and 132 to send and receive data and information and access system 100.

System 100 can additionally include one or more databases/servers 110-114, each of which can be configured as any suitable type of data storage component. As illustrated in FIG. 1, system 100 can include one or more abilities database 110 that can be configured to store abilities data associated with job criteria and qualifications. As described in greater detail below, abilities data may include skills data, tasks data, and/or competency data. System 100 can include a candidate database 112 that can be configured to store data and information related to individual candidates utilizing system 100. System 100 can include a job application/employer database 114 that can be configured to store data and information related to individual client-employers and related to job applications for individual client-employers. While not specifically shown in FIG. 1, system 100 may also include any number of other various databases for storing other types of data and information associated with system 100. Each database may be configured to be in communication with networked computing system 102 using any suitable connection, such as a network-based connection.

As further shown in FIG. 1, system 100 may include one or more modules in connection with computing system 102, including an analysis module 116 and one or more submodules 118-128, configured for performing specific steps and processes utilized by system 100. As illustrated, system 100 may include a natural language processing (NLP) module 118 configured to parse, tokenize, map, associate and process text provided by either employers (relating to job application data) or candidates (relating to candidate qualifications/resume data). System 100 may include a data validation module 120 configured to analyze and ensure the validity of data and information processed through system 100 and its various applications and modules.

System 100 may include an abilities matching module 122 configured to match abilities data associated with a client-candidate or a job position for a client-employer with abilities data stored in abilities database(s) 110. The abilities matching module 122 can be configured to match and associate skills data, tasks data and competency data received from an applicant to stored skills data, tasks data and competency data that has been associated with job and qualifications data.

System 100 may include a job application/candidate report generator module 124 configured to generate reports for employers or job creators. The job application/candidate report generator module 124 can be configured to generate reports regarding a specific job position of an employer, multiple job positions for a single employer, and/or generate reports for candidates regarding a single position, related positions by the same employer, and or similar positions from other employers.

Report generator module 124 can create various types of reports utilizing the data and information processed and utilized by system 100. According to one embodiment, report generator module 124 can be configured to create a report for a job position provided by a client-employer. The job position report can utilize job application data a client-employer provided with a job position and create a report identifying key job description data for the job position, identified key abilities (e.g., skills, tasks and competencies associated by system 100) and other information.

Report generator module 124 may also be configured to generate a candidate pool analysis (CPA) report for a client-employer. As described in greater detail below, the CPA report may contain a ranked or tiered list of qualified candidates for a job positioned based on the job application data provided and processed by system 100 and analyzed candidate qualifications data for one or more client-candidates. Report generator module 124 may also be configured to provide individual candidate reports for client-employers for one or more qualified candidates identified in a CPA report. The individual candidate reports can include analyzed candidate data for a qualified candidate, including resume data, work experience analysis, personality assessment data, and fit to job application data provided for the employer's job position. The reports generated by module 124 can have any desired or suitable format comparing and summarizing analysis of job positions and candidates. According to one embodiment, the generated report can include a two-plane graph diagram showing a talent score (based on a job positions required abilities, skills, etc. and/or a candidate's abilities, skill, etc.) on one axis and a potential score (based on a job positions required personality or attitude data and/or a candidate's calculated personality or attitude data) on another axis. According to another embodiment, the report generated by module 124 can include a five-dimensional graph diagram charting a job position or candidate's talent, potential, cost, promotion ability and cultural fit based on the data and information calculated and analyzed by system 100.

System 100 may include a resume builder module 126 configured to generate a tailored resume directed to a selected job type or a specific job application/position posted by a client-employer. The resume builder module 126 can utilize resume data and/or personality assessment data provided by a client-candidate, identify a preferred job type or position, process, analyze and match the provided candidate data to identify candidate date associated with abilities and qualifications for the preferred job type or position, and generate a resume emphasizing the most relevant candidate data for the preferred job type position. System 100 and resume builder module 126 can be configured to generate customized resumes for any number of different job types and/or positions, ranging from entry level positions to executive positions, depending on the particular embodiment of the present invention.

System 100 may include a candidate analysis generator module 128 configured to provide an analyzed report for a client-candidate based on the information provided by the client-candidate. Module 128 can generate a business intelligence (BI) report based on resume data, work experience data and personality assessment data provided by the client-candidate. Module 128 can also be configured to generate BI reports for a specific job description or position for which one or more candidates are being analyzed, where the report utilizes candidate data along with job position data, and business culture data specific to the job position. Module 128 can also be configured to analyze a client-candidate's past work experience data and resume data and generate a report suggesting career promotions and identify the abilities and skills needed to advance or receive a promotion or move on to a next career.

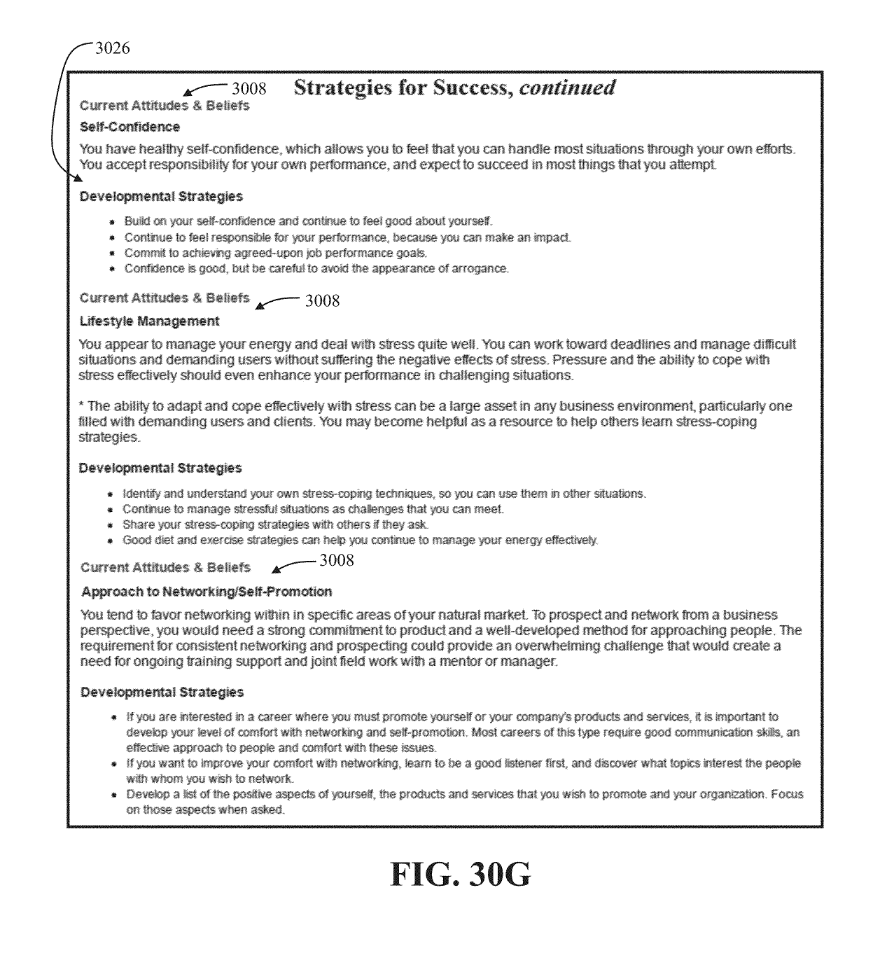

Module 128 can also be configured to generate a career choice GPS assessment report based on the resume data, work experience data and personality assessment data provided by the client-candidate. According to one embodiment as described in greater detail below, the career choice assessment report can analyze candidate personality data based on a set of question/answer responses to identify candidate personality data relating to learned traits, inherent behaviors, attitudes, beliefs and fit scores associated with specific job types and positions. An exemplary career choice GPS assessment report is illustrated in FIGS. 30A-30G and described in greater detail below.

Module 128 can further provide a candidate gap analysis report based on resume data, work experience data and personality assessment data provided by the client-candidate. For the gap analysis report (and for the BI report), module 128 can analyze resume data and work experience data that has been processed and analyzed by the NLP module 118, data validation module 120 and abilities matching data 122 in order to identify key abilities (skills, tasks and competencies, and work experiences for the candidate. In particular, according to one embodiment, the gap analysis report generated by module 128 can identify abilities data and personality data of a candidate compared to those required for a specific job type or position and identify the abilities and/or personality data consistent with the that job type or position and the abilities and/or personality data the candidate is lacking for the job type or position.

System 100 (through modules 116-128 or any other modules configured into system 100) can be configured to analyze data collected by system 100 in any number of different ways and generate reports for client-employers and client-candidates identifying information related to such analysis. According to one embodiment, system 100 can be utilized to identify effective teams of existing employees for a client-employer. System 100 (through analysis module 116) can receive, process and analyze (as described herein) work experience data, personality data, job position data and other data from existing employees and existing job positions for the client-employer, and identify cross-functional teams that are effective and diverse in order to improve productivity, morale, and client-employer effectiveness. According to one embodiment, system 100 can retain analyzed data for client candidates in client-candidate database 112 even after a client-candidate is matched and hired for a job position posted by a client-employer, and then later utilized within system 100 in the event the client-candidate re-enters the job market. According to one embodiment, system 100 can be utilized as a planning tool for client-employers by analyzing job positions, analyzing existing employees and job positions to improve employer culture and identify effective teams, and as a planning tool for client-candidates by creating analyzed client-candidate reports as described above. According to one embodiment, system 100 can be used as a recruiting tool to assist in identifying qualified client-candidates (as described herein) conducting interviews, and extending job offers. According to one embodiment, system 100 can be utilized as a workforce management tool by analyzing data and information of a client-employer for existing employees to enhance team building, employee records and manage employee movement. According to one embodiment, system 100 can be utilized as a talent management tool for succession planning, performance management and career planning for both client-candidates and client-employers. According to one embodiment, system 100 can be utilized as an employee development tool by analyzing the abilities data and personality data (and changes in the data) for existing employees of a client-employer (or for a client-candidate over time). According to one embodiment, system 100 can be utilized as an off-boarding tool by analyzing work, potential and skill gaps for job positions and client-candidates.

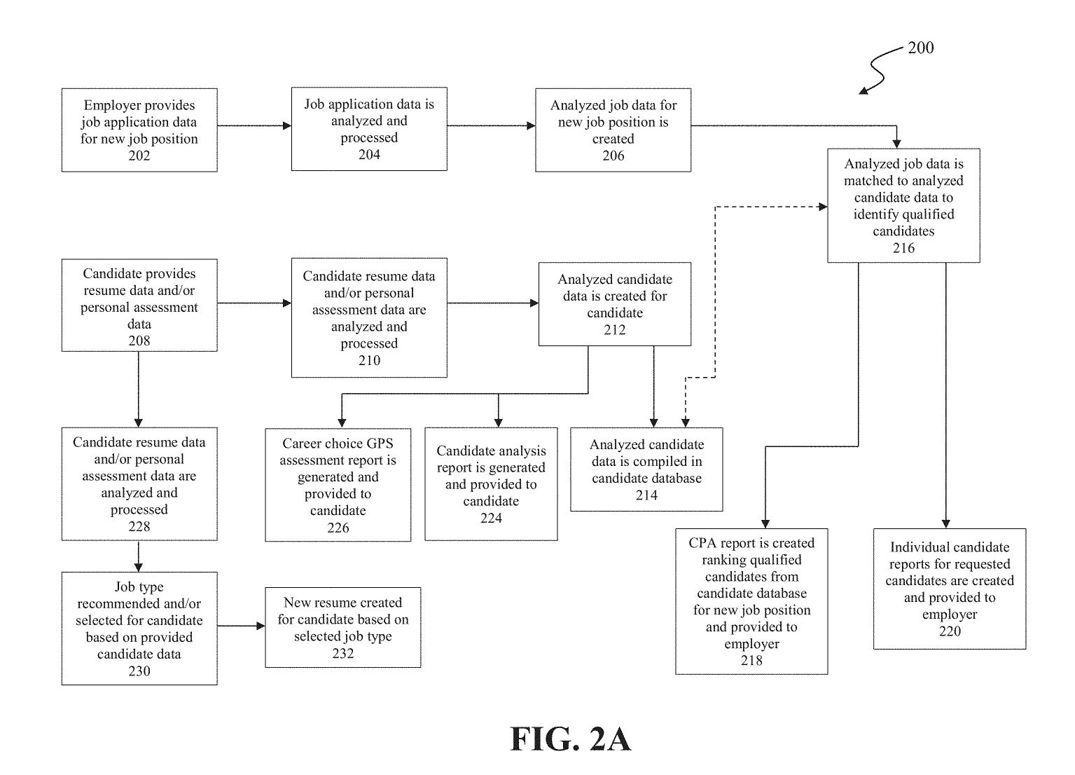

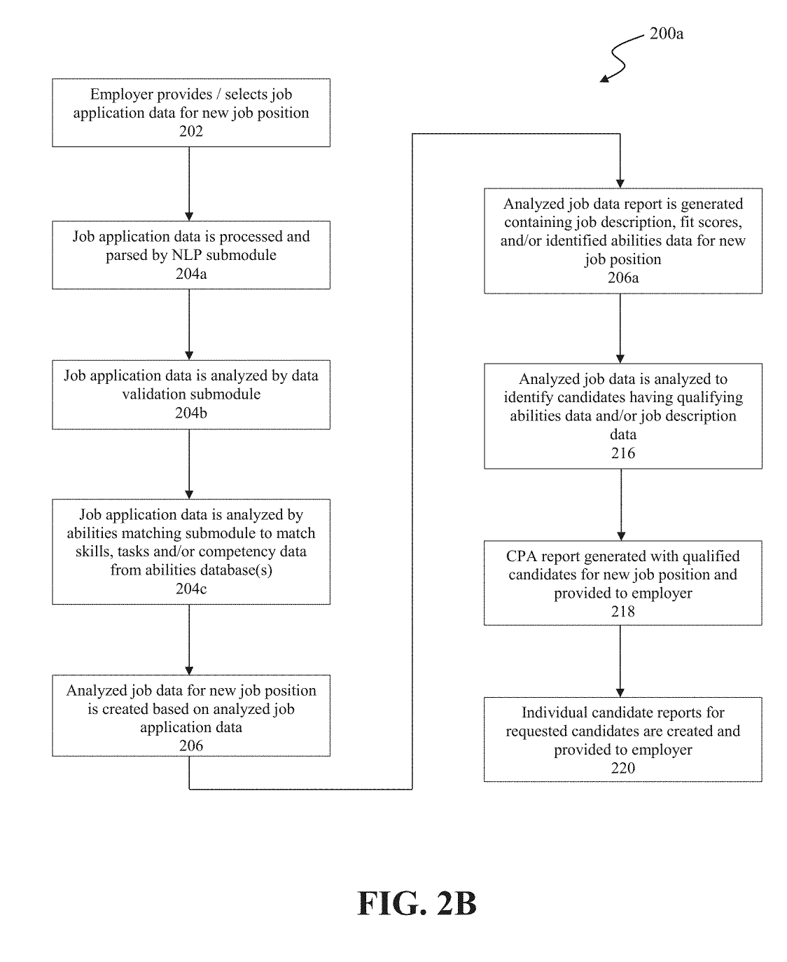

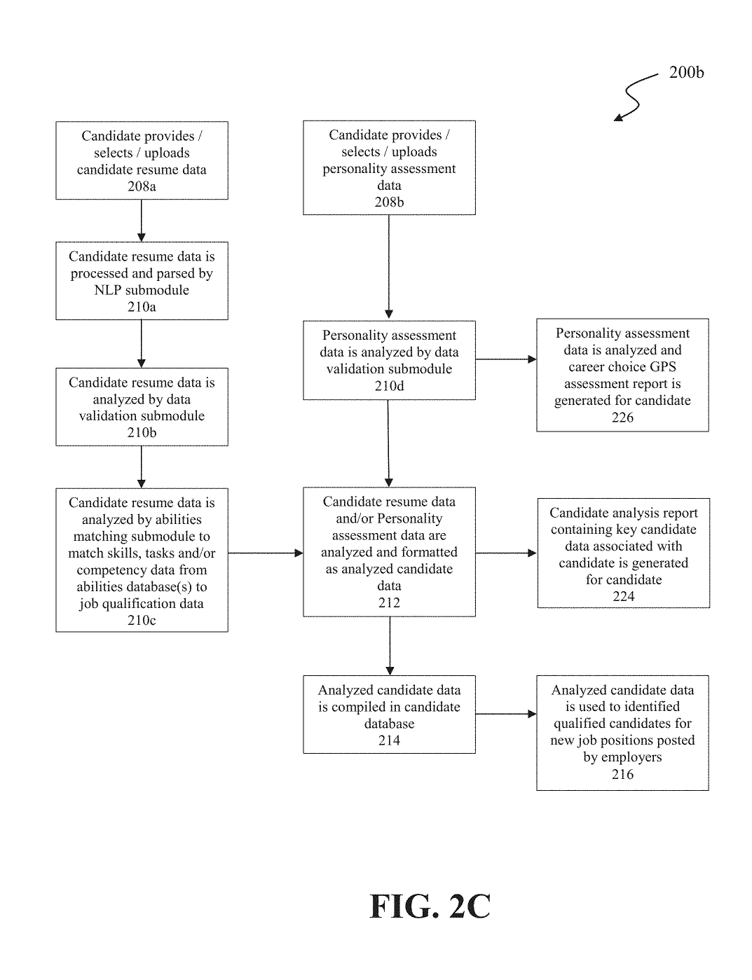

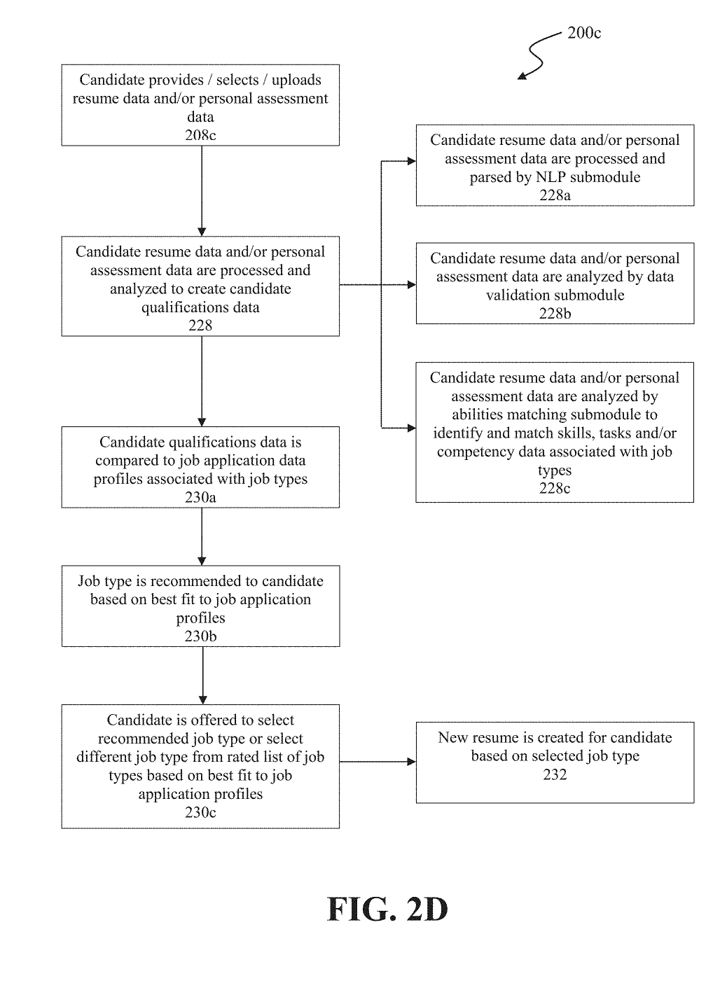

Referring to FIGS. 2A-2D, a process 200 for a job matching method is illustrated schematically as a flow chart according to one embodiment of the present invention. Process 200 can be utilized in connection with system 100 of FIG. 1 in order to automatically identify potential candidates for employer job positions based on analyzed job description data and candidate data and assist candidates in identifying job positions based on job position qualifications and analyze candidate data. As illustrated, FIG. 2A provides an overall process 200 for a job matching method according to one embodiment of the present invention utilizing both client-employer data and client-candidate data to identify qualified candidates for new job positions provided by a client-employer based on candidate qualifications matching job data for the new job position, identify job positions for client-candidates that are best fits for the client-candidate based on provide candidate data, and create resumes for client-candidates containing candidate data most relevant to selected job positions. FIG. 2B illustrates a process 200a as part of overall process 200 for enabling a client-employer to identify qualified candidates for a new job position; FIG. 2C illustrates a process 200b as part of overall process 200 for enabling client-candidates to identify job positions for client-candidates that are best fits for the client-candidate; FIG. 2D illustrates a process 200c as part of overall process 200 for enabling client-candidates to create resumes for containing candidate data most relevant to selected job positions.

As shown in FIG. 2A, process 200 can begin at step 202 where a client-employer provides job application data for a new job position. Job application data can include job description data, abilities data (including skills data, tasks data and competencies data) and fit scores required for the new job position. The job application data can be provided by the client-employer by selecting standardized and/or predefined job description data, abilities data and fit scores and/or by manually entering description data, abilities data and fit scores for the new job position. The job application data can be provided by the client-employer by utilizing a client-employer computing device connected to system 100. At step 204, the provided job application data can be analyzed and processed by system 100. As shown in FIG. 2B, the analysis step 204 can include a step 204a where the job application is processed and parsed by NLP module 118, a step 204b where the job application data is validated by data validation module 120, and a step 204c where the job application data is analyzed and matched to defined abilities data using the abilities matching module 122. After the provided job application data is analyzed at step 204, analyzed job data for the new job position can be created at step 206. The analyzed job data can include a processed job description for the new job position and required abilities data and fit scores associated with the new job position based on defined abilities data from abilities database(s) 110.

As shown in FIGS. 2A and 2C, at step 208, client-candidates can provide resume data and/or personal assessment data. Each client-candidate and select, upload or otherwise provide the resume data and/or personal assessment data using a client-candidate computing device 130 connected to system 100. As shown in FIG. 2C, at step 210, the client-candidate resume data and personal assessment data can be analyzed by system 100 through the one or more modules 116-122 of system 100. At step 210a, client-candidate resume data can be processed and parsed using NLP module 118 in order to identify abilities data (e.g., skills data, tasks data and competencies data associated with the client-candidate. At step 210b, the resume data can be validated using data validation module 120. At step 210c, the abilities data from the resume data can be analyzed and matched to defined abilities data from the abilities database(s) 110 of system 100 in order to identify and match the client-candidate's abilities associated with the client-candidate. At step 210d, the personal assessment data provided by the client-candidate can be analyzed and validated using data validation module 120. After the provided resume data and personal assessment data is analyzed by system 100, at step 212, analyzed candidate data is created for the client-candidate containing identified abilities data associated with the client-candidate and stored in candidate database 112 of system 100 as shown by step 214.

As shown in FIGS. 2A-2C, after the analyzed job data for a new job position has been created and analyzed candidate data has been created, at step 216, the analyzed job data can be matched to analyzed candidate data from candidate database 112 using analysis module 116 in order to identify qualified candidates for the new job position. During step 216, the job description data, abilities data and fit scores associated with the new job position can be matched to candidates within candidate database 112 based on a candidate's abilities data and other candidate data associated each candidate to identify the best fit of candidates for the new job position using techniques and processes defined herein. Following step 216, at step 218, a candidate pool analysis (CPA) report can be generated for the client-employer of the new job position identified the most qualified client-candidates for the new job position. The CPA report can include a work experience analysis, personal assessment data and key abilities data associated with each client-candidate identified at step 216 and provided to the client-employer. At step 220, individual candidate reports containing relevant candidate data can additionally be generated for the client-employer of the new job position. The client-employer can then use the CPA report and individual candidate reports to identify and select a qualified candidate for the new job position.

As shown in FIGS. 2A and 2C, after the analyzed candidate data has been created for a client-candidate, at step 222, a candidate analysis report can be generated for a client-candidate identifying the key work experience data and abilities data associated with the candidate. The candidate analysis report can be created by system 100 through module 128 as shown in FIG. 1. The candidate analysis report can comprise a BI report and/or gap analysis report identifying candidate work experience data and abilities data associated with the candidate based on the analyzed candidate data for the candidate and identifying needed work experience data and abilities data for certain job types and/or job positions.

As shown in FIGS. 2A and 2C, at step 224, a career choice GPS assessment report can be generated and provided the a client-candidate based to identify job types and/or job positions relevant to the client-candidate based on the personal assessment data provided by the client-candidate.

As shown in FIGS. 2A and 2D, process 200 can further be utilized to create resumes for a client-candidate based on provided candidate resume data and/or personal assessment data and identified or selected job types or job positions as shown by steps 208 and 228-232. At step 208, as described above, a client-candidate can provide resume data and/or personal assessment data associated with the client candidate using a client-candidate computing system 130 connected to system 100. As shown in FIG. 2D, at step 228, the provided client-candidate resume data and/or personal assessment data can be analyzed by system 100 through the one or more modules 116-122 of system 100. At step 228a, client-candidate resume data and/or personal assessment data can be processed and parsed using NLP module 118 in order to identify abilities data (e.g., skills data, tasks data and competencies data associated with the client-candidate. At step 228b, the resume data and/or personal assessment data can be validated using data validation module 120. At step 228c, the abilities data from the resume data can be analyzed and matched to defined abilities data from the abilities database(s) 110 of system 100 in order to identify and match the client-candidate's abilities associated with the client-candidate. As further shown in FIG. 2D, the analysis step 228 can be utilized to create candidate qualifications data for the client-candidate containing known abilities data and personal assessment data identified from the resume data and personal assessment data provided by the client at step 208.

After the provided resume data and personal assessment data is analyzed by system 100, at step 230, the candidate qualifications data can be utilized match the client-candidate to job types and/or job positions best fit for the client-candidate by comparing job application data profiles associated with known job types, as illustrated at step 230a. At step 230b, one or more job types are recommended to the client-candidate based on the best match of candidate qualifications data to job application data for a known job type. At step 230c, the client-candidate can select the recommended job type or select a different job type provided by system 100 based on other interests. System 100 can be configured to provide different job types based on a rating of best fit analysis using the candidate qualifications data created for the client-candidate. At step 232, after selecting a job type through system 100, a new resume can be created for the client-candidate based on the selected job type using the resume builder module 126. The new resume generated by the client-candidate can incorporate the candidate qualifications data, including abilities data, most relevant to the selected job type.

As shown in FIGS. 2A-2C, method 200 can provide one or more processes for matching job positions to candidates and matching candidates to job positions. As described herein, these processes and method 200 overall can be utilized in connection with system 100 to create a comprehensive and automated system where client-employers can post job positions into system 100 and client-candidates are automatically matched to job position through the processing steps of method 200. Reports for both client-employers and client-candidates can be generated and provided in order to facilitate the matching of qualified client-candidates and qualified job positions from client-employers.

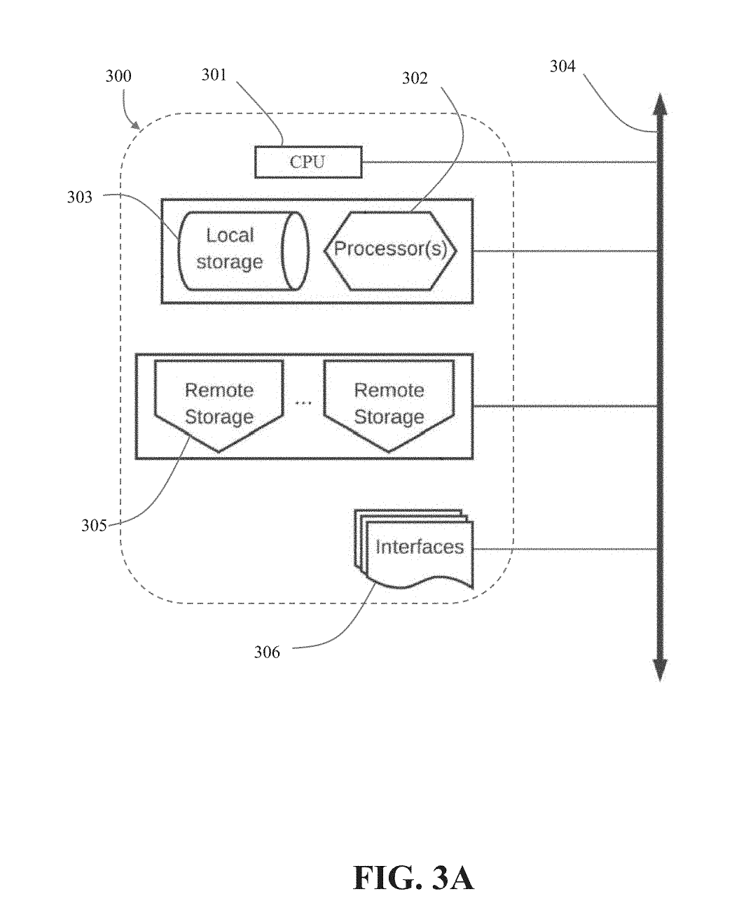

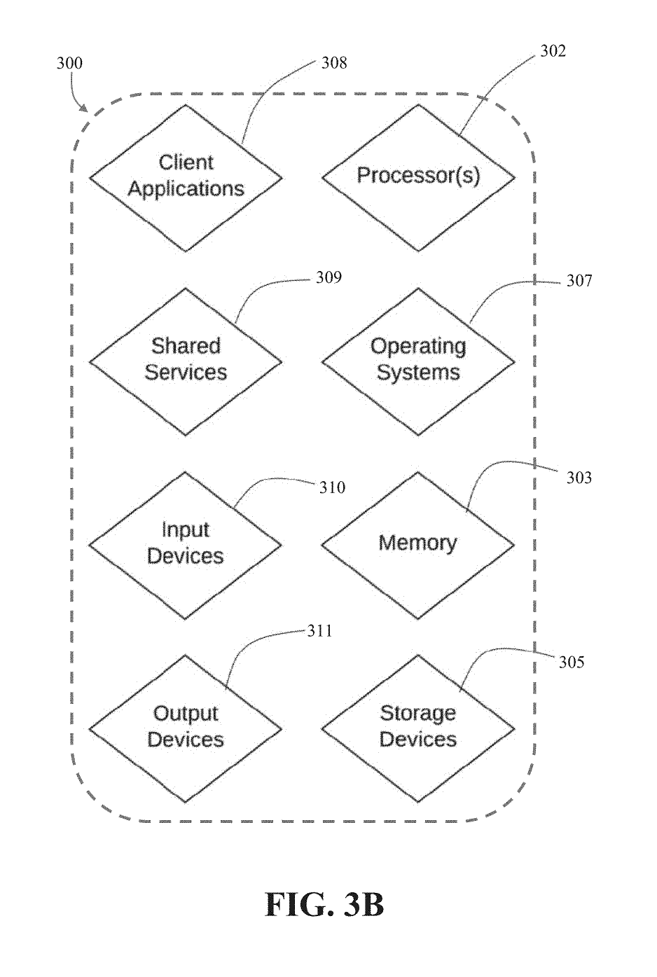

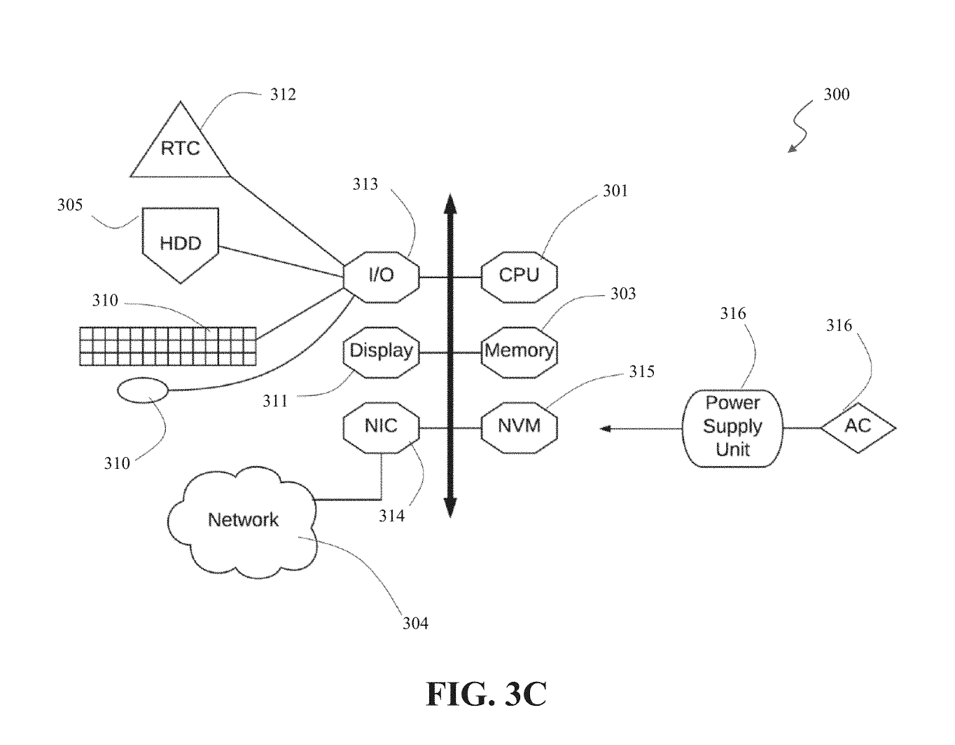

Referring now to FIGS. 3-29, additional embodiments and components of system 100 and process 200 will be described in greater detail. FIG. 3A provides an exemplary hardware architecture for a computing component 300, which can be utilized in system 100 in accordance with one embodiment of the present invention. Computing component 300 can be configured as a client-candidate computing device 130, a client-employer computing device 132, and/or computing network 102 utilized within system 100 to connect client-candidates and client-employers with system 100 and carry out the operations and processes associated with system 100 to provide the job matching features and functions of system 100 as described herein. Computing component 300 can be configured as any electronic device capable of executing software or hardware-based instructions according to one or more programs stored in memory, including but not limited to a computer, laptop, tablet, mobile device, server system, or other electronic computing device.

As shown in FIG. 3A, according to one embodiment, computing component 300 can include a CPU 301, one or more additional processors 302, a local storage component 303, a connection to communications network 304, a remote storage component 305 and one or more interfaces 306. The central processing unit (CPU) 301 can be configured for implementing specific functions and processes of device 300, including those associated with the job matching process features of system 100 and process 200 described herein. CPU 301 can be configured as any suitable type of processing unit, including, but not limited to, a system-on-a-chip (SOC) type hardware, a Qualcomm SNAPDRAGON™, or a Samsung EXYNOS™ CPU.

As shown in FIG. 3A, computing device 300 can be configured for connection with a communications network 304 configured as connectable network allowing computing device 300 to connect with the various components of system 100 to exchange data and information with other computing devices, systems and networks and one another using any suitable type of protocols. In some embodiments, communications network 304 may comprise a personal area network, a wireless personal area network, a local area network, a wireless local area network, a wireless mesh network, a wireless wide area network, a cellular network, a wide area network, an enterprise private network, a virtual private network, an intranet, an extranet, an Internetwork, an Internet, a near field communications, a mobile telephone network, a CDMA network, a GSM cellular networks, or a WiFi network.

As shown in FIG. 3A, computing device 300 can incorporate one or more processors 302 for carrying out one or more sets of instructions, programming operations and tasks of computing device 300, including those associated with system 100, and can be configured as any suitable type of processor, including but not limited to an Intel processor, an ARM processor, a Qualcomm processor, an AMD processor, application-specific integrated circuits (ASICs), electrically erasable programmable read-only memories (EEPROMs), field-programmable gate arrays (FPGAs), a mobile processor, a microprocessor, a microcontroller, a microcomputer, a programmable logic controller, or a programmable circuit.

As shown in FIG. 3A, computing device 300 can incorporate a local memory component 303 configured to store data, information, programs, sequences of instructions, program state information, etc. on a temporary or permanent basis for use in computing device 300 or other computing or electronic device that may be configured to connect to system 100. Local memory component 303 may be configured as any suitable memory component, including, but not limited to, non-volatile random access memory (RAM), read-only memory (ROM), or one or more levels of cached memory. Local memory component 303 may be configured to perform one or both of (i) cache and/or store data and (ii) store programming instructions, depending on the particular embodiment of the present invention.

As shown in FIG. 3A, computing device can incorporate a remote memory component 305 configured to store, backup and/or recover data, programs, applications, and other information associated with system 100 and/or computing device 300. Remote memory component 305 can be configured as any suitable type of remote storage, including, but not limited to, physical or virtual servers, data centers, service or other storage mechanism.

As shown in FIG. 3A, computing device 300 can include one or more interface components 306. Interface components 306 may comprise a mechanism to control the sending and receiving of data packets over a computer network or support peripherals used with system 100 (such as interfaces 108 with respect to system computing network 102), computing device 300 or other computing device associated with system 100. Interface 306 can be configured as any suitable interfacing component, including, but not limited to network interface cards (NICs), ethernet interfaces, frame relay interfaces, cable interfaces, DSL interfaces, token ring interfaces, graphics interfaces, universal serial bus (USB) interfaces, Serial port interfaces, Ethernet interfaces, FIREWIRE™ interfaces, THUNDERBOLT™ interfaces, PCI interfaces, parallel interfaces, radio frequency (RF) interfaces, BLUETOOTH™ interfaces, near-field communications interfaces, 802.11 (WiFi) interfaces, frame relay interfaces, TCP/IP interfaces, ISDN interfaces, fast Ethernet interfaces, Gigabit Ethernet interfaces, Serial ATA (SATA) or external SATA (ESATA) interfaces, a high-definition multimedia interface (HDMI), a digital visual interface (DVI), analog or digital audio interfaces, asynchronous transfer mode (ATM) interfaces, high-speed serial interface (HSSI) interfaces, Point of Sale (POS) interfaces, or fiber data distributed interfaces (FDDIs).

Referring to FIG. 3B, a schematic diagram of an exemplary logical architecture for a computing component 300 configured as a client computing device for use with system 100 is illustrated according to one embodiment of the present invention. As shown, the client-based computing component 300 can include one or more processors 302 and local and remote memory storage components 303 and 305, respectively as described above. As further shown in FIG. 3B, client-based computing component 300 can include an operating system 307, client applications 308, shared services component 309, an input device 310 and an output device 311. Operating system(s) 307 can comprise a system software that can manage computer hardware and software resources and provides common services for computer programs, including, but not limited to, Microsoft's WINDOWS™, Apple's Mac OS/X, iOS operating systems, a Linux operating system, or Google's ANDROID™ operating system. Client applications 308 can comprise one or more software applications configured enable client-employers and client-candidates to use and access system 100, including selecting, uploading or otherwise providing job application data (for client-employers) and resume and personal assessment data (for client-candidates) in order to utilize the job matching and analysis and resume creation features of system 100 as described herein. Share services 309 can comprise web-enabled services or functionality related to system 100 in connection with client applications 308. Input device(s) 310 can comprise a component of any suitable type for receiving client input, including, but not limited to, a keyboard, a touchscreen, a microphone, a mouse, a touchpad, a trackball and the like. Output device(s) 311 can comprise a component of any suitable type for outputting system 100 related information (such as CPA reports, individual candidate reports, candidate analysis reports, BI reports, gap analysis reports GPS assessment reports and/or resumes in accordance with the features of system 100 as described herein), including, but not limited to, screens for visual output, a speaker, a printer and the like.

Referring to FIG. 3C, a schematic diagram of an exemplary hardware architecture of a computing component 300 is illustrated. As shown in FIG. 3C, in addition to the components described above with reference to FIGS. 3A and 3B, computing component 300 may comprise a real time clock 312, input/output units 313, a network interface controller (NIC) component 314, a non-volatile memory component 315 and a power supply 316. Real time lock 312 may comprise a component that keeps track of the current time and may be configured as an integrated circuit. Input/output units 313 may comprise devices used by clients to communicate with system 100, including but not limited to input components 310 and output components 311 described above. NIC component 314 may comprise a computer hardware component configured to connect computing component 300 to another computing device 300 and/or the other components of system 100 through communications network 304. Non-volatile memory component 315 may comprise a computer memory that can retrieve stored information for computing component 300 even after having been power cycled (turned off and back on). Power supply 316 may comprise an electronic device that supplies electric energy to an electrical load for powering the operation of computing component 300.

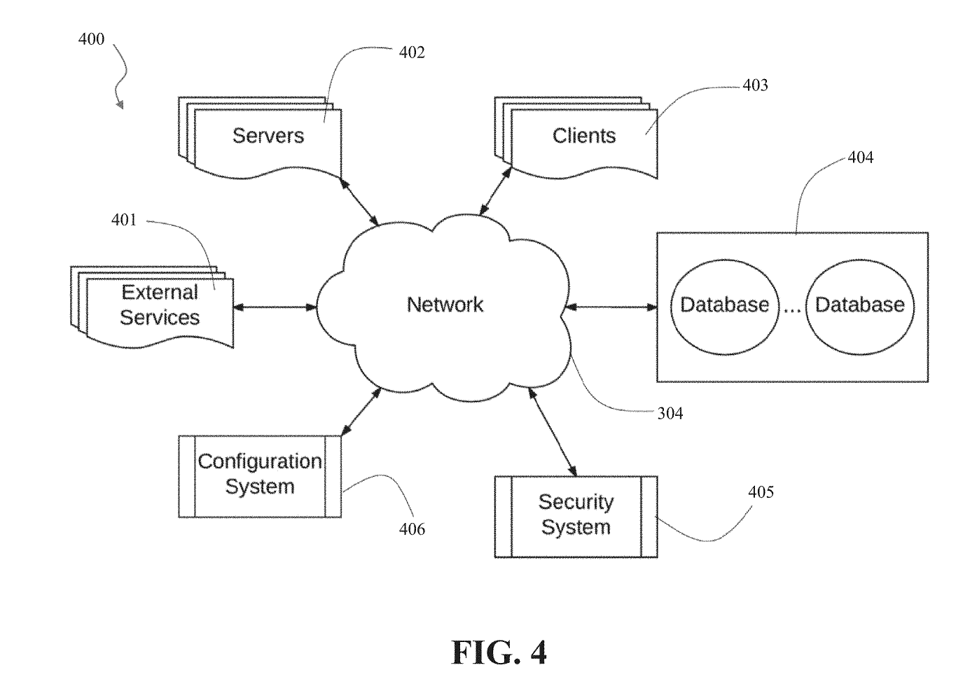

Referring to FIG. 4, a schematic diagram of an exemplary architecture for a distributed computing network 400 configured for use with system 100 in accordance with one embodiment of the present invention. Distributed computing network 400 can function as a network arrangement of computer components enabling the operation of system 100 and allowing client-employers and client-candidates to utilize system 100 as described herein. As shown, distributed computing network 400 can include an external service 401 comprising web-enabled services or functionality related to or installed on a computing device 300 utilized by a client-candidate, a client-employer or system 100. Server 402 may comprise a computing device 300 configured to handle requests received from one or more clients (including client-employers and client candidates) over communications network 304. Clients 403 may comprise one or more computing devices 300 with program instructions for implementing client-side portions of the system 100 and enable clients to utilize the job matching functions of system 100 as described herein. Database(s) 404 may comprise any suitable database configurations for allowing an organized collection of data within a program instructions related system, including but not limited to, a relational database system, a NoSQL system, a Hadoop system, a Cassandra system, a Google BigTable, column-oriented databases, in-memory databases, or clustered databases. According to one embodiment, database(s) 404 may comprise 110-114 as illustrated in FIG. 1. Database(s) 404 may be configured to allow the definition, creation, querying, update and administration of client-employer data, client-candidate data and standardized abilities data and job-type data utilized by system 100. Security system 405 may comprise a system common to information technology (IT) and web functions that implements security related functions for the system 100. Configuration system 406 may comprise a system common to information technology (IT) and web functions that can implement configurations and management of system 100.

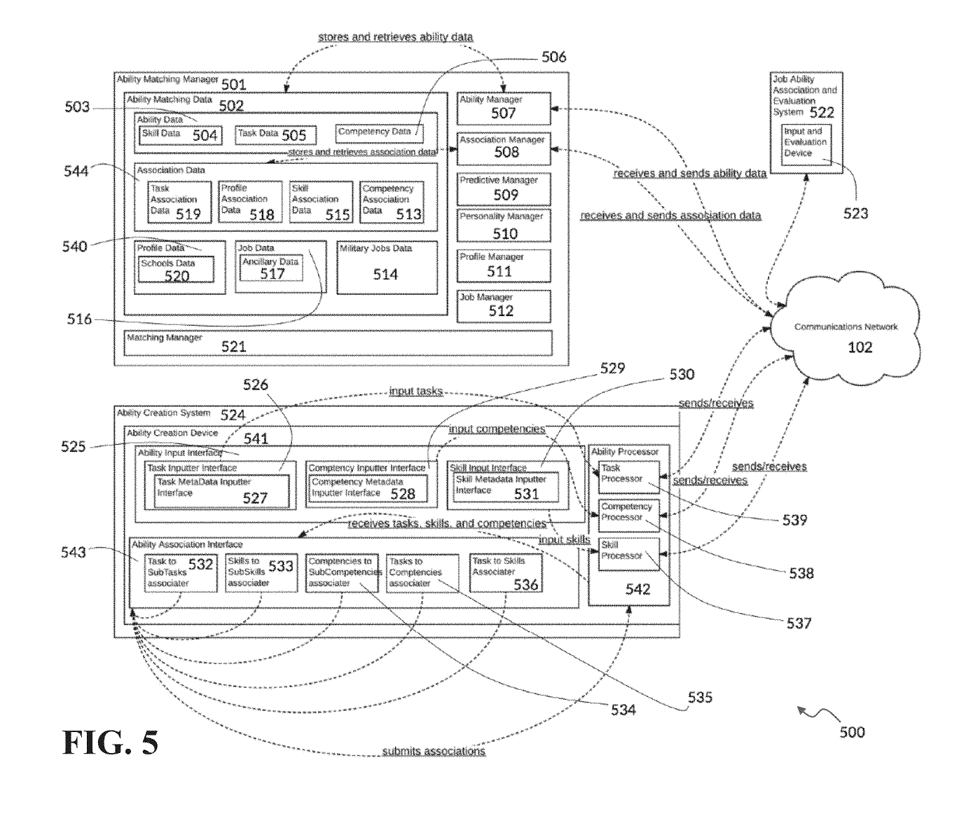

Referring now to FIG. 5, a schematic diagram of an ability matching system 500 that may be utilized in connection with system 100 and process 200 in accordance with one embodiment will be shown and described. As best shown in FIG. 5, ability matching system 500 can comprise an ability matching manager 501, a job ability and evaluation system 522 and an ability creation system 524 (each described in greater detail below). Ability matching system 500 may be configured as a component of system 100 (and utilized to carry out one or more steps of process 200) and configured to enable the creation and/or identification of abilities, associating them with tasks and competencies, and developing abilities data. For example, FIG. 1 illustrates system 100 as having an analysis module 116, an abilities matching submodule 122, and one or more abilities databases 110 in addition to several other components. Ability matching system 500 may be configured as a sub-component of system 100 that is utilized in connection with and/or in place of one or more of analysis module 116, abilities matching submodule 122 and abilities databases 110. Similarly, FIGS. 2A-2D illustrate several steps of process 200 where abilities data from either client-candidates, client-employers and/or standardized or pre-defined abilities data is utilized in the job matching methods and functions of the present invention, and such steps of process 200 can incorporate and utilized the ability matching system 500 described herein.

As shown in FIG. 5, ability matching system 500 may comprise an ability matching manager 501. Ability matching manager 501 can comprise an overall system that allows for the creation of a profile of abilities and tasks that can be used to match jobs types and positions to client candidates and predict job types and positions that may be suited for a client-candidate. Ability matching manager 501 can further be utilized to identify candidates having abilities relevant to a job type/position for a client-employer and identify job types/positions relevant to the abilities of a client-candidate. According to one embodiment, as shown in FIG. 5, ability matching manager 501 may comprise an ability matching data 502, an ability manager 507, an association manager 508, a predictive manager 509, a personality manager 510, a profile manager 511, a job manager 512, and a matching manager 521.

Ability matching data 502 can comprise a database or data objects regarding specific abilities that an individual (e.g., a client-candidate or potential client-candidate) may have. According to one embodiment, ability matching data 502 may comprise, ability data 503, job data 516, profile data 540, association data 544, and optionally, military jobs data 514.

Ability data 503 can comprise a database or data objects regarding specific abilities that an individual may have that may be relevant to performing job tasks. According to one embodiment, ability data 503 may comprise skill data 504, task data 505, and competency data 506.

As part of ability data 503 (as shown in FIG. 5), skill data 504 can comprise a database or data objects regarding skills that an individual may be able to perform that is required for a task. For exemplary purposes only and not to be viewed as limiting, skill data 504 may include: the skill of computer programming data, the skill of welding data, the skill of machine operation data, the skill of carpentry data, the skill of firing a gun data, the skill of cleaning a gun data, the skill of repairing a car data, the skill of repairing a car engine data, or the skill of repairing a transistor data, etc. According to one embodiment, skill data 504 may comprise skill data value and skill metadata.

As part of ability data 503 (as shown in FIG. 5), task data 505 can comprise a database or data objects regarding specific tasks that an individual may do that may be relevant to performing job tasks. For exemplary purposes only and not to be viewed as limiting, task data 505 may include: a fireman's ability to put out a fire data, a police officer's ability to control a crowd data, or the ability to do accounting data, etc. According to one embodiment, task data 505 may comprise task data value and task metadata.

As part of ability data 503 (as shown in FIG. 5), competency data 506 can comprise a database or data objects regarding knowledge that an individual may have that is required for a task. For exemplary purposes only and not to be viewed as limiting, competency data 506 may include: Teamwork Data, Initiative Data, Dependability Data, Time management Data, Judgement Data, Decision Making Data, Integrity Data, Trust Data, Problem Solving Data, Results Oriented Data, Critical Thinking Data, Ability to Learn Data, Flexibility Data, Conflict Management Data, Business Acumen Data, Priority Setting Data, Strategic Thinking Data, Perseverance Data, Building Effective Teams Data, Managing and Measuring Work Data, Motivating Others Data, Managing and Reducing Ambiguity Data, or Planning Data. According to one embodiment, competency data 506 may comprise competency data value and competency metadata.

As described above (and shown in FIG. 5), ability matching data 502 can include job data 516, which can comprise data or data objects relating to a description of the performance of the job. Job data 516 can enable the system 500 (and system 100 overall) to store job descriptions so that they may be grouped and categorized as being defined by their associations to tasks, skills, competencies, and ability data 503. According to one embodiment, job data 516 may comprise ancillary data 517. Ancillary data 517 can comprise a peripheral definition as related to a job or job description that would be important for characterizing different skills and tasks for characterizing ability data 503. In some embodiments, it is thought that examples of ancillary data 517 may include: years of relevant experience required data, required knowledge data, required skills data, prerequisite skills data, or prerequisite competencies data.

As described above (and shown in FIG. 5), ability matching data 502 can include profile data 540, which can comprise a database or data objects regarding personal information that is uniquely identified within the system 500 (and system 100 overall). For exemplary, non-limited purposes, profile data 540 may include: name data, email data, phone data, past job description data, schooling data, school data, personality information data, geographical information data, social connections data, or target career goals and jobs data. According to one embodiment, profile data 540 can include schools data 520 as shown in FIG. 5. Schools data 520 can comprise a database or data objects regarding school or education related information that is uniquely identified within the system. For exemplary, non-limited purposes, schools data 520 may include: school name data, graduation dates data, GPA data, colleges attended data, course schedules data, individual course grades data, teachers data, mentors data, tests taken data, or test scores data.

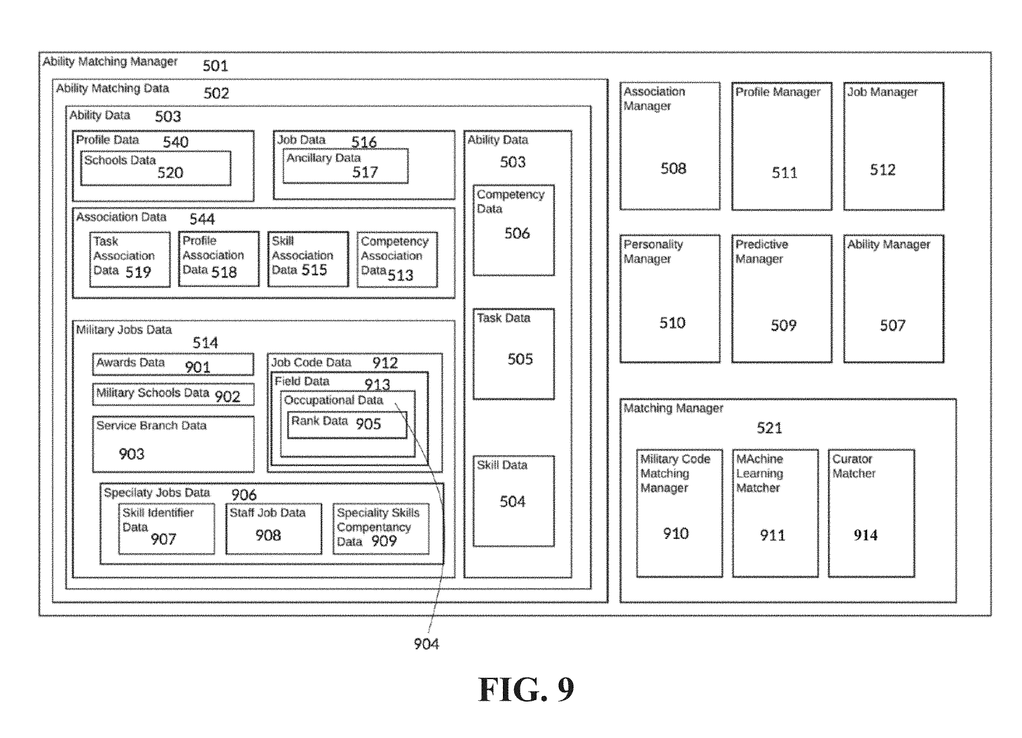

As described above (and shown in FIG. 5), ability matching data 502 can include military jobs data 514, which can comprise data or data objects as related to military job descriptions that are standardized in an existing hierarchy. Military jobs data 514 can comprise service branch data 903, military schools data 902, awards data 901, specialty jobs data 906, and job code data 912 (see FIG. 9). In addition, while the embodiment illustrated in FIG. 5 refers specifically to military jobs data 514, in other embodiments of the present invention, the ability matching data component 502 can additionally and/or alternatively include jobs data related to other industry/occupation/field specific jobs data. For example, in addition to or alternatively to a component directed specifically to military jobs data, ability matching data 502 could include a component directed specifically to engineering jobs data, computer-based jobs data, science jobs data, business jobs data, education jobs data, customer service jobs data, etc.

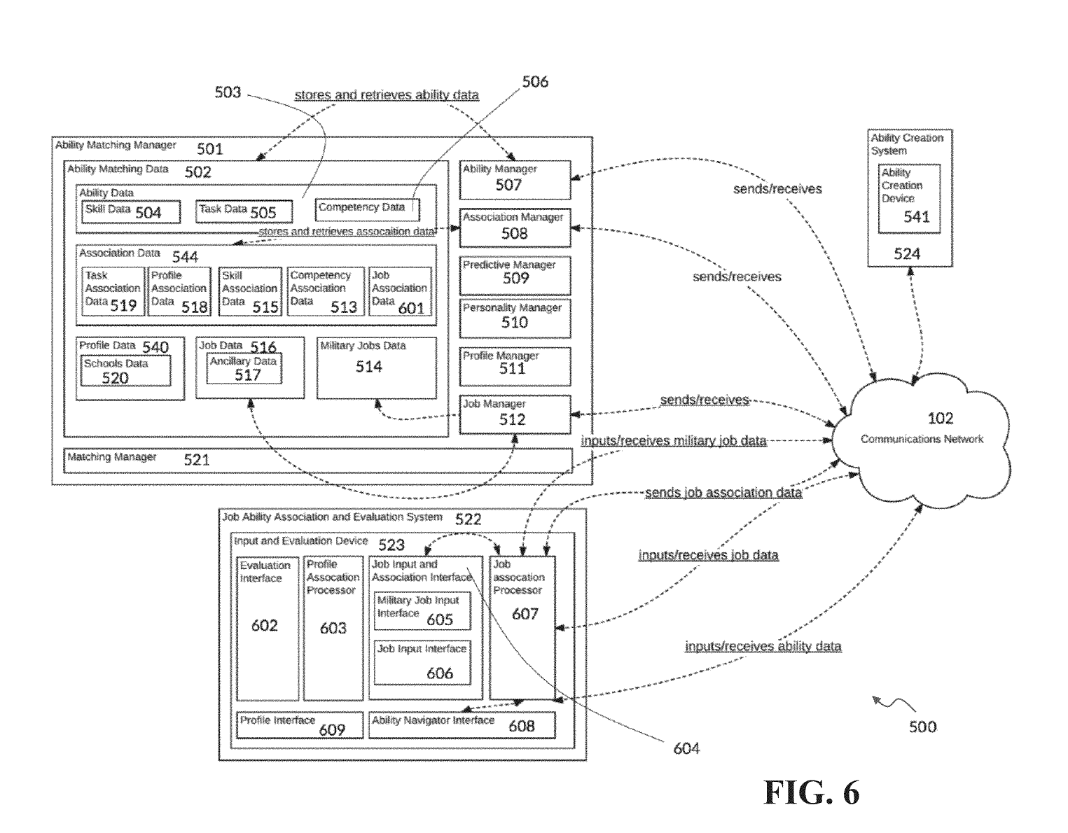

As described above (and shown in FIG. 5), ability matching data 502 can include association data 544, which can comprise a database or data objects that serve to relate one or more data models of the system 500 (and system 100 overall) to one another, for example, as a unique or foreign key. Association data 544 can be configured to enable one or more models to be associated with other models in the system 500 (or system 100 overall) through a unique identifier, for example, a piece of information that relates to competency of a waitress providing good customer service to the task of being a waitress and the skill of setting the table correctly. According to one embodiment, association data 544 may comprise, and finally, competency association data 513, skill association data 515, profile association data 518, task association data 519, and job association data 601 (see FIG. 6).

As part of association data 544, competency association data 513 can comprise a database or data objects that serve to relate one or more competency association data 513 with other data models of the system 500 (an system 100 overall), for example, as a unique or foreign key. Competency association data 513 can be configured to allow competencies to be associated with other models in the system 500 (and system 100 overall) through a unique identifier.

As part of association data 544, skill association data 515 can comprise a database or data objects that serve to relate one or more skills with other data models of the system 500 (and system 100 overall), for example, as a unique or foreign key. Skill association data 515 can be configured to allow skills to be associated with other models in the system through a unique identifier.

As part of association data 544, profile association data 518 can comprise a database or data objects that serve to relate one or more profiles with other data models of the system (and system 100 overall), for example, as a unique or foreign key. Profile association data 518 can be configured to allow profiles to be associated with other models in the system 500 (and system 100 overall) through a unique identifier.

As part of association data 544, task association data 519 can comprise a database or data objects that serve to relate one or more tasks with other data models of the system 500 (and system 100 overall), for example, as a unique or foreign key. Task association data 519 can be configured to allow tasks to be associated with other models in the system 500 (and system 100 overall) through a unique identifier.

As described above (and shown in FIG. 5), ability matching manager 501 can also include ability manager 507, which can comprise one or more modules that process the abilities, their data relations, communications, and associations.

As described above (and shown in FIG. 5), ability matching manager 501 can also include association manager 508, which can comprise one or more modules that process the associations, their data relations, communications, and associations.

As described above (and shown in FIG. 5), ability matching manager 501 can also include predictive manager 509, which can comprise one or more modules that allow profile data 540 that has been linked to job data 516 to calculate the difference in ability data 503 via skills, tasks, and competencies to a target job.

As described above (and shown in FIG. 5), ability matching manager 501 can also include personality manager 510, which can comprise one or more modules that receive and/or process personality information (i.e., personal assessment data as referred to in FIGS. 1-2) as related to a profile (e.g., candidate profile or job profile) and characterizes this or manages the associations with job data 516 and/or ability data 503. Personality manager 510 can enable a client-candidate (end user) to more specifically match their personality to job types, job positions and/or job descriptions via abilities and further, in some embodiments, can allow for the association of relationships between abilities and personalities, specifically unrelated to a profile or job information data.

As described above (and shown in FIG. 5), ability matching manager 501 can also include profile manager 511, which can comprise one or more modules that process the profiles, their data relations, communications, and associations.

As described above (and shown in FIG. 5), ability matching manager 501 can also include job manager 512, which can comprise one or more modules that process the jobs, their data relations, communications, and associations.

As described above (and shown in FIG. 5, ability matching manager 501 can also include matching manager 521, which can comprise one or more modules that implements algorithms for determining ability data 503 association with job data 516 through an automated means. According to one embodiment, matching manager 521 can comprise a machine learning matcher 911 and/or a military code matching manager 910 (see FIG. 9).

Referring still to FIG. 5, ability matching system 500 can also include job ability association and evaluation system 522 as referenced above. Job ability association and evaluation system 522 can comprise a system of devices, interfaces, and communications that can allow for the matching of abilities to jobs (e.g., job types and positions) and profiles (e.g., job profiles and candidate profiles). Job ability association and evaluation system 522 can be configured to allow the configuration and association of job descriptions with abilities that have been stored in the system 500 (or system 100 overall), such as inputting the job description of a waitress and loading relevant abilities, then specifically configuring the abilities as related to the job description.

According to one embodiment, job ability association and evaluation system 522 can comprise input and evaluation device 523. Input and evaluation device 523 can comprise a computing component (such as component 300 according to one embodiment) used to associate and evaluate job data 516, profile data 540, and ability data 503. Input and evaluation device 523 can be configured to allow a computing component 300 to configure and associate job descriptions with abilities that have been stored in the system 500 (and system 100 overall), such as inputting the job description of a waitress and loading relevant abilities, then specifically configuring the abilities as related to the job description. According to one embodiment, input and evaluation device 523 can comprise job input and association interface 604, profile interface 609, evaluation interface 602, profile association processor 603, and finally, job association processor 607 (see FIG. 6).

Referring still to FIG. 5, ability matching system 500 can also include ability creation system 524 as referenced above. Ability creation system 524 can comprise a system of modules, devices, and communications that allows for the input of abilities and associated sub-data for use of matching abilities to jobs types/positions and profiles (for job applications and/or candidates). Ability creation system 524 can be configured to allow one or more end users (e.g., client-employers, client-candidates and others) to input different abilities and associate them with tasks and skills. According to one embodiment, ability creation system 524 can comprise an ability creator device 541.

Ability creator device 541 can comprise a standard computing component (such as a computing component 300) and can be configured to allow the creation of abilities that can be used for job type/position and profile associations. Ability creator device 541 can further be configured to allow input or receive input of abilities, tasks, and skills. According to one embodiment, ability creator device 541 can comprise an ability processor 542, an ability input interface 525, and an ability association interface 543.

Ability input interface 525 can a graphical user interface (GUI) that can be configured to accept ancillary data 517 as well as other types of data from an end user (e.g., client-employer, client-candidate or other user). Ability input interface 525 can be configured to allow the input of components of abilities, such as competencies, tasks, and skills. As shown in FIG. 5, ability input interface 525 can comprise a task inputter interface 526, a competency inputter interface 529, and a skill input interface 530 according to one embodiment.

As part of ability input interface 525 (as shown in FIG. 5), task inputter interface 526 can comprise a graphical user interface that can be configured to accept task data 505 from an end user (e.g., client-employer, client-candidate or other user). According to one embodiment, task inputter interface 526 can comprises task metadata inputter interface 527. Task metadata inputter interface 527 can comprises a graphical user interface that can be configured to accept task metadata from an end user (e.g., client-employer, client-candidate or other user). Task metadata inputter interface 527 can be configured to allow the input of various types of metadata related to tasks, such as, but not limited to, average salary related to the task and average age of person performing the task.

As part of ability input interface 525 (as shown in FIG. 5), competency inputter interface 529 can comprise a graphical user interface that can be configured to accept competency data 506 from an end user. One goal of competency inputter interface 529 is to allow the input of competencies, such as the knowledge of how to repair a tire. Competency inputter interface 529 preferably comprises competency metadata inputter interface 528. Competency metadata inputter interface 528 comprises a graphical user interface that accepts competency metadata from an end user (e.g., client-employer, client-candidate or other user). Metadata inputter interface 528 can be configured to allow the input of various types of metadata related to competency, such as difficulty level, geographical locations, links, and peripheral data related to the competency.

As part of ability input interface 525 (as shown in FIG. 5), skill input interface 530 can comprise a graphical user interface that can be configured to accept skill data 504 from an end user (e.g., client-employer, client-candidate or other user). Skill input interface 530 can be configured to allow the input of skills, such as, but not limited to, the ability to use a wrench. According to one embodiment, skill input interface 530 can comprise skill metadata inputter interface 531. Skill metadata inputter interface 531 can comprise a graphical user interface that can be configured to accept skill metadata from an end user (e.g., client-employer, client-candidate or other user). Skill metadata inputter interface 531 can be configured to allow the input of various types of metadata related to skills, such as, but not limited to, relative difficulty to acquire the skills and percentage of population that has such skill.

As described above (and shown in FIG. 5), ability creation device 541 can also include ability processor 542, which can comprise a module responsible for processing ability data 503 and its relationships to other types of data, and for communicating with other components of the system 500 (and system 100 overall) through communications network 304 or other communication method. Ability processor 542 can be configured to allow the communication of ability data 503 between components of system 100 and users, allow for processing of data 503 (and other data) as related to interface of abilities and the sending, modifying, and receiving of associated data. As shown in FIG. 5, according to one embodiment, ability processor 542 can comprise a competency processor 538, a skill processor 537, and a task processor 539 according to one embodiment.

As part of ability processor 542, skills processor 537 can comprise a module responsible for processing skill data 504 and its relationships to other types of data, and for communicating with other components of the system 500 (and system 100 overall) through communications network 304 or other suitable communication method. Skill processor 537 can be configured to allow the communication of skill data 504 between components of system 100 and users, and allow for the processing of skill data 504 as related to interface of skills and the sending, modifying, and receiving of associated data.

As part of ability processor 542, competency processor 538 can comprise a module responsible for processing competency data 506 and its relationships to other types of data, and for communicating with other components of the system 500 (and system 100 overall) through communications network 304 or other suitable communication method. Competency processor 538 can be configured to allow the communication of competency data 506 between components of system 100 and users, and allow for the processing as related to interface of competencies and the sending, modifying, and receiving of associated data.

As part of ability processor 542, task processor 539 can comprise a module responsible for processing task data 505 and its relationships to other types of data, and for communicating with other components of the system 500 (and system 100 overall) through communications network 304 or other suitable communication method. Task processor 539 can be configured to allow the communication of task data 505 between components of system 100 and users, and allow for the processing as related to interface of tasks and the sending, modifying, and receiving of associated data.

As described above (and shown in FIG. 5), ability creation device 541 can also include ability association interface 543, which can comprise one or more graphical user interfaces that can be configured to allow system 100 and/or an end user (e.g., a client-employer, client-candidate or other user of system 100) to configure associations with ability data 503 to other data models in the system 500 (and system 100 overall). Ability association interface 543 can be configured to allow for the presentation of a display to the end user (e.g., client-candidate and/or client-employer) to associate tasks data, skills data, subtasks data, and competencies data to one another, sometimes in parent-child relationships. As shown in FIG. 5, according to one embodiment, ability association interface 543 can comprise a task to subtasks associater 532, a skills to subskills associater 533, and a competencies to subcompetencies associater 534, a tasks to competencies associater 535, and a task to skills associater 536.

As part of ability association interface 543, the task-to-subtasks associater 532 can comprise a graphical user interface that can allow system 100 and/or an end user of system 100 to configure task data 505 to subtasks data. The task to subtasks associater 532 can be configured to allow tasks to be related to subtasks for use within system 500 and system 100 overall. As a non-limiting example, an association of a task to a subtask could be a restaurant waitress must also be able to be a restaurant hostess.

As part of ability association interface 543, the skills-to-subskills associater 533 can comprise a graphical user interface that can be configured to allow system 100 and/or an end user of system 100 to configure skill data 504 to subskills data. The skills to subskills associater 533 can be configured to allow skills to be related to subskills for use within system 500 and system 100 overall. As a non-limiting example, an association of skill to a subskill could be that one must know how to climb a ladder before they can do roof work.

As part of the ability association interface 543, the competencies-to-subcompetencies associater 534 can comprise a graphical user interface that can be configured to allow system 100 and/or an end user of system 100 to configure competency data 506 to subcompetencies data. The competencies to subcompetencies associater 534 can be configured to allow competencies to be related to subcompetencies for use within system 500 and system 100 overall. As a non-limiting example, an association of competency to a subcompetency could be that one must know how to use a computer before they can use a specific program.

As part of ability association interface 543, the tasks-to-competencies associater 535 can comprise a graphical user interface that can be configured to allow system 100 and/or an end user of system 100 to configure task data 505 to competency data 506. The tasks to competencies associater 535 can be configured to allow tasks to be related to competencies for use within system 500 and system 100 overall. As a non-limiting example, an association of a task to a competency could be that a restaurant hostess must have knowledge of polite customer service.

As part of ability association interface 543, the task-to-skills associater 536 can comprise a graphical user interface that can be configured to allow system 100 and/or an end user of system 100 to configure task data 505 to skill data 504. The task to skills associater 536 can be configured to allow tasks to be related to skills for use within system 500 and system 100 overall. As a non-limiting example, an association of a task to a skill could be that in order to be a waitress, one must be able to count money.

Referring now to FIG. 6, a schematic diagram of one embodiment of ability matching system 500 illustrating how system 500 can be used as part of overall system 100 (and within process 200) for inputting and/or creating job application descriptions for job positions and associating the job application description data with abilities data. As shown in FIG. 6, ability matching system 500 according to such an embodiment can include ability matching manager 501, ability creation system 524, and job ability association and evaluation system 522 as described above with reference to FIG. 5.

As shown in FIG. 6, the ability matching data component 544 of ability matching manager 501 can additionally comprise a job association data 601. Job association data 601 can comprise a database or data objects that serve to relate one or more jobs with other data models of the system 500 (and system 100 overall), such as, for example, a unique or foreign key. Job association data 601 can be configured to allow jobs data to be associated with other models in the system 100 through a unique identifier.

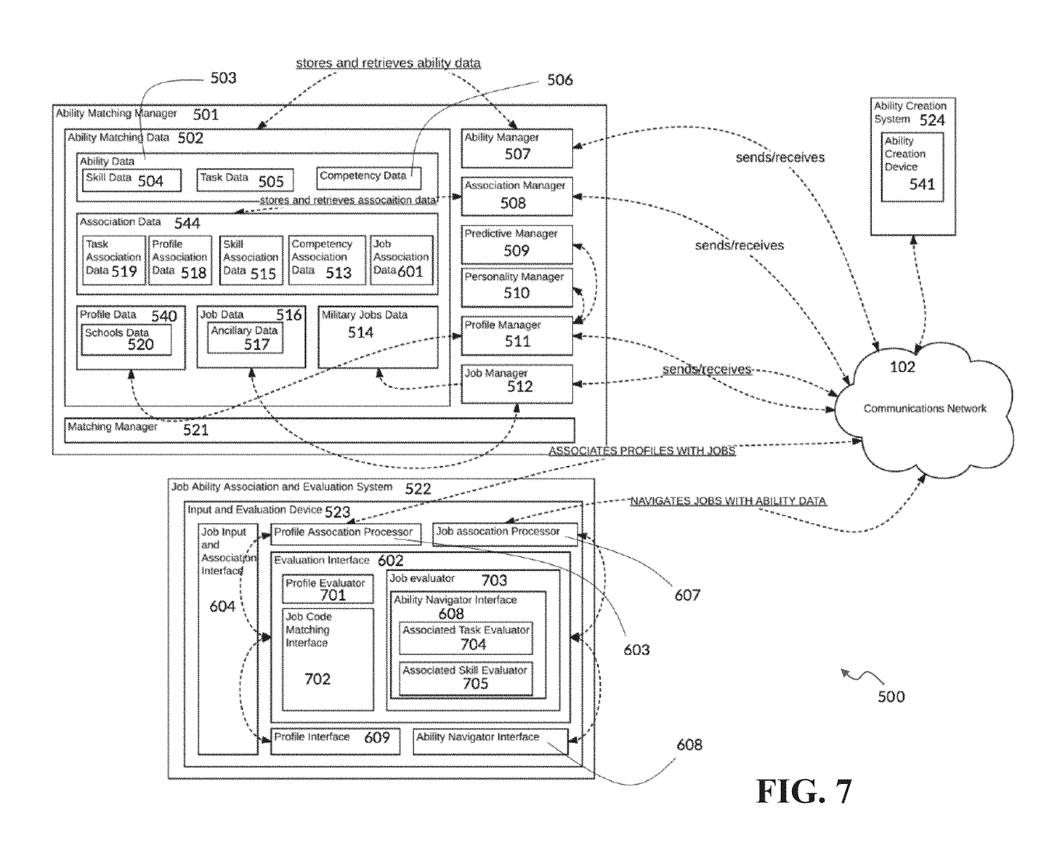

As shown in FIG. 6, the input and evaluation device component 523 of the job ability association and evaluation system 522 can comprise an evaluation interface 602, a profile association processor 603, a job input and association interface 604, a job association processor 607, an ability navigator interface 608 and a profile interface 609. Evaluation interface 602 can comprise a graphical user interface that can be configured to allow a profile (e.g., candidate profile or job position profile) to evaluate jobs (types or positions) associated with ability data 503 of a profile. Evaluation interface 602 can be configured to allow system 100 and/or a user of system 100 (e.g., client-employer, client-candidate or other user) to navigate relevant job descriptions and potential job descriptions and compare their profile related information to jobs (types or positions) that exist in the system 100. As shown in FIG. 7 (and described below), evaluation interface 602 can comprises a profile evaluator 701, a job code matching interface 702, and a job evaluator 703.

Profile association processor 603 can comprise one or more modules of programming instructions that can link the navigation of the evaluation interface 602 with a candidate profile (or potentially a job application profile) so the ability data 503 in the profile can be associated with one or more job data 516. The profile association processor 603 can be configured to allow the association of job descriptions to a candidate's profile within system 100. A non-limiting example of this function could be the querying of waitress related skills and identifying previous tasks as something that one has performed in the past and is capable of performing or doing.

Job input and association interface 604 can comprise a graphical user interface that can be configured to allow an end user (e.g., client-employer or client-candidate or other user of system 100) to input a job type/position and associate the job type/position with ability data 503. Job input and association interface 604 can be configured to have a display that allows the input of job descriptions and other job related identifiers such as a MOS code that is then associated with tasks, skills, and other ability data. As shown in FIG. 5, job input and association interface 604 can comprise a job input interface 606 and, optionally, a military job input interface 605. The Job input interface 606 can comprise a graphical user interface that can allow system 100 and/or an end user to input a job type/position and associate the job type/position with ability data 503. Job input interface 606 can also be configured to have a display that can allow the input of job descriptions for a job type/position, such as the abilities and experiences required for being a waiter/waitress at an upscale restaurant. Military job input interface 605 can comprise a graphical user interface that can allow system 100 and/or an end user to input a military job type/position and associate the job with ability data 503. Military job input interface 605 can be configured to have a display that can allow the input of a military branch job code and give a mechanism to associate it with abilities, such as inputting NEC code and deriving that this is an ensign level cadet with sharpshooting abilities, for example.

Job association processor 607 can comprise one or more modules of programming instructions that can function to associate job data 516, ability data 503 and profile data 540. Job association processor 607 can be configured to allow jobs (types and/or positions) and job descriptions to be associated with abilities. As a non-limiting example, a waitress having to have the skills of counting money, setting out a dinner table, and the competencies of friendly customer service could be an association of a job position and job description with abilities.

Ability navigator interface 608 can comprise a graphical user interface that can allow system 100 and/or an end user (e.g., a client-employer, client-candidate or other user) to interact with ability data 503 while it is associated with job data 516 to determine the related tasks, skills, and competencies associated with job data 516. The ability navigator interface 608 can be configured to allow interaction with abilities as related to a job type/position and navigation through related tasks, skills, and competencies. As shown in FIG. 7 (and described below), ability navigator interface 608 can comprise an associated task evaluator 704 and an associated skill evaluator 705.

Profile interface 609 can comprise a graphical user interface that can be configured for allowing a client-candidate (or potentially a client-employer or other user of system 100) to input resume data and other data, such as, but not limited to, past job, education, and other profile related information such as name, age, education level, email, and other information that can be used to uniquely identify a person in the system 100. Profile interface 609 can be configured to allow the system 100 to specifically configure job descriptions and their related skills and abilities as pertaining to an individual user (i.e., client-candidate) in the system 100.

Referring now to FIG. 7, a schematic diagram of one embodiment of ability matching system 500 illustrating how system 500 can be used as part of overall system 100 (and within process 200) for associating job descriptions with profile data and personal data. As shown in FIG. 7 and described above, ability matching system 500 can include ability matching manager 501, ability creation system 524, and job ability association and evaluation system 522 as described above with reference to FIGS. 5 and 6. With specific reference to the evaluation interface component 602 of the job ability association and evaluation system 522, the evaluation interface component 602 can include a profile evaluator 701, a job code matching interface 702, and a job evaluator 703 to enable system 500 (and system 100 overall) to associate job descriptions with profile data and personal data from client-candidates (and potentially client-employers and other users of system 100).

Profile evaluator 701 can comprise a graphical user interface that can allow an end user of system 100 (e.g., client-candidate, client-employer or other user) to navigate profile data 540. Profile evaluator 701 can be configured to allow interaction with an end user profile and its various associations and job relations, such as displaying profile information, visually indicating jobs, visually indicating the end user's job profile with an intended job, and the end user's profile relevant to other users.

Job code matching interface 702 can comprise a graphical user interface that can allow system 100 and/or a user of system 100 (e.g., client-candidate or client-employer) to provide or input job description or job data 516. Job code matching interface 702 can be configured to allow interaction with a job and its various associations and other job relations, as related to one or more job codes.

Job evaluator 703 can comprise a graphical user interface that can allow system 100 and/or a user of system 100 to navigate instances of job data 516. Job evaluator 703 can be configured to allow interaction with a job and its various associations and other job relations, such as visually indicating jobs, and navigation through related tasks, skills, and competencies. According to one embodiment as shown in FIG. 7, job evaluator 703 can comprise ability navigator interface 608 (described above with reference to FIG. 6). As further shown in FIG. 7, job evaluator 703 and ability navigator interface 608 can comprise an associated task evaluator 704 and an associated skill evaluator 705. Associated task evaluator 704 can comprise a graphical user interface that can allows system 100 and/or a user of system 100 to navigate task data 505 when associated with job data 516. Associated skill evaluator 705 can comprise a graphical user interface that can allow system 100 and/or a user of system 100 to navigate task data 505 when associated with skill data 504.

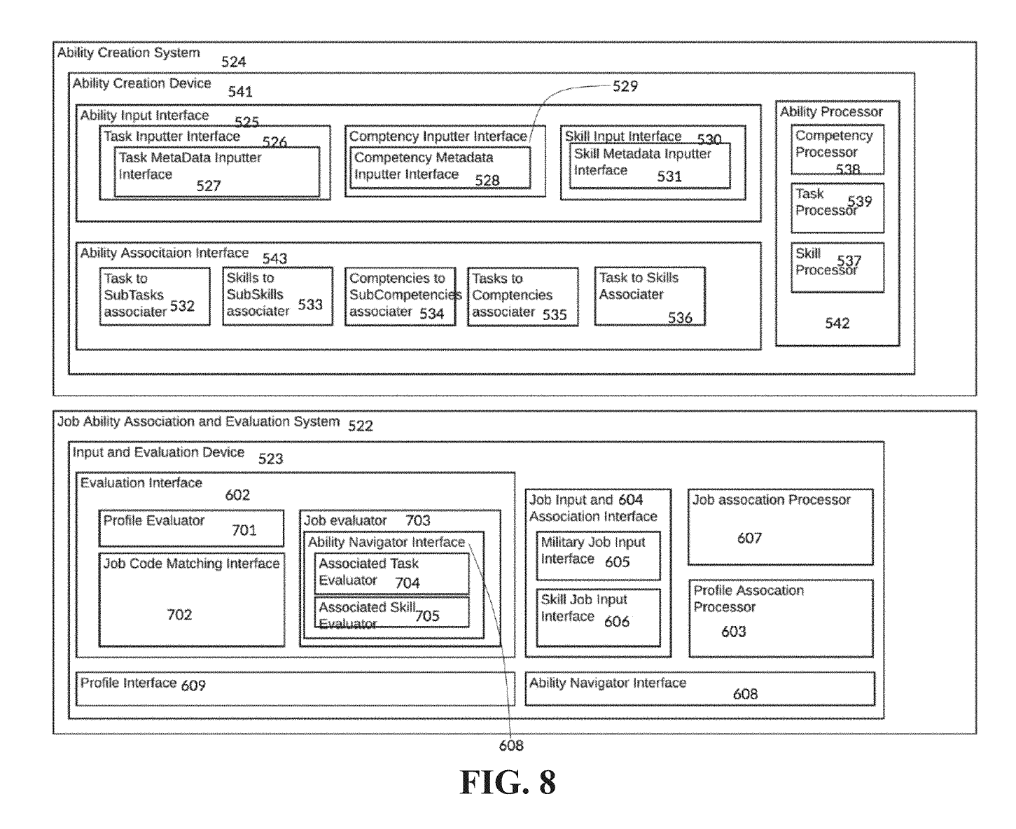

Referring now to FIGS. 8 and 9, which collectively provide schematic diagrams of ability creation system 524, job ability association and evaluation system 522 and ability name manager 501 to illustrate the modular relationships of components of the ability matching system 500 in accordance with one embodiment of the present invention. As shown in FIG. 9, the ability matching data 502 and the matching manager 521 of ability matching system 500 can include a military-specific jobs data component 514. As described above, the military-specific jobs data 514 represents just one possible specific jobs data module and it is recognized that ability matching data 502 and matching manager 521 (and ability matching system 500) can include any number of different industry, occupation or field specific jobs data modules in various embodiments of the present invention. For example, ability matching data 502 can include an engineering jobs data module, a science jobs data module, a business jobs data module, a customer service jobs data module, or any other type of specific jobs data module. Accordingly, while the specific jobs data module 514 described herein is specific to military jobs data, the same teachings, functions and operations can be similarly applied to any other type of specific jobs data module 514 where the specific sub-modules or data sets are directed to specific features within the specific industry, occupation or field.

As shown in FIG. 9, military jobs data 514 can include awards data 901, military schools data 902, service branch data 904, specialty jobs data 906, and job code data 912. Awards data 901 can comprise data or data objects related to awards given as commendation for particular service. Non-limiting examples of awards data 901 may include: a silver star medal data, a purple heart medal data, a distinguished service medal data, a medal of honor data, a legion of merit medal data, a distinguished flying cross medal data, a bronze star medal data, a presidential unit citation medal data, or a prisoner of war medal data. Military schools data 902 can comprise data or data objects as related to schools within the military or military type schools related to military training and/or specialized military training. Non-limiting examples of military schools data 902 may include: special forces schools data, mechanic schools data, officer training school data, aviation school data, infantry school data, sniper school data, combat medic school data, ordnance bomb disposal school data, or rescue swimmer school data. Service branch data 906 can comprise data or data objects indicating service in a particular military branch. Non-limiting examples of service branch data 903 may include: Army data, Navy data, Air Force data, Marines data, Army Reserves Data, Army National Guard Data, Navy Reserves Data, Navy National Guard Data, Marines Reserves Data, Marines National Guard Data, Coast Guard Data, or Coast Guard Reserves Data.

As further shown in FIG. 9, military jobs data 514 can include specialty jobs data 906, which can comprise data or data objects related to specific training for jobs that are not generalized as part of the typical hierarchy of military service, but are recognized as military skills or specialties. According to one embodiment, specialty jobs data 906 can comprise skill identifier data 907, staff job data 908, and specialty skills competency data 909. Skill identify data 907 can comprise data or data objects that serve as a unique identifier for specialized military skills as related to specialty military jobs. Staff job data 908 can comprise data or data objects as related to staffing jobs within the military such as, but not limited to, clerking, administration, and management. Specialty skills competency data 909 can comprise data or data objects that reflect particular competencies as associated with specialty jobs. Non-limiting examples of specialty skills competency data 909 may include: survival training data, medical training data, translator training data, communications training data, and legal training data.

As further shown in FIG. 9, military jobs data 514 can also include job code data 912, which can comprise data or data objects related to a military job service code. As shown, according to one embodiment, job code data 912 can comprise field data 913. Field data 913 can comprise data or data objects related to the field of a military job. Non-limiting examples of field data 913 may include: Infantry Men data, Mechanics data, Construction data, Medical data, Cyber Security data, Special Forces data, Intelligence data, Pilots data, Shipdrivers data, and Pump Drivers data. As shown, according to one embodiment, field data 913 can comprise occupational data 904. Occupational data 904 can comprise data or data objects related to an occupation within a field of a military job. Non-limiting examples of occupational data 904 may include: YH60 Blackhawk Pilot data, Neurosurgeon data, F-15 pilot data, Mortar man data, Infantryman data, and Special forces engineer data. As shown, according to one embodiment, occupational data 904 can comprise rank data 905, which can include data or data objects related to the rank within an occupation within a field of a military job.

As further shown in FIG. 9, the matching manager component 521 of the ability matching manager 501 (of ability matching system 500) can include a military code matching manager 910, a machine learning matcher 911, and a curator matcher 914. Military code matching manager 910 can comprise one or more modules that can be configured to match ability data 503 to military jobs data 514 through one or more algorithms. Machine learning matcher 911 can comprise one or more modules that can be configured for matching tasks to jobs based on history of tasks that have been input into system 100.

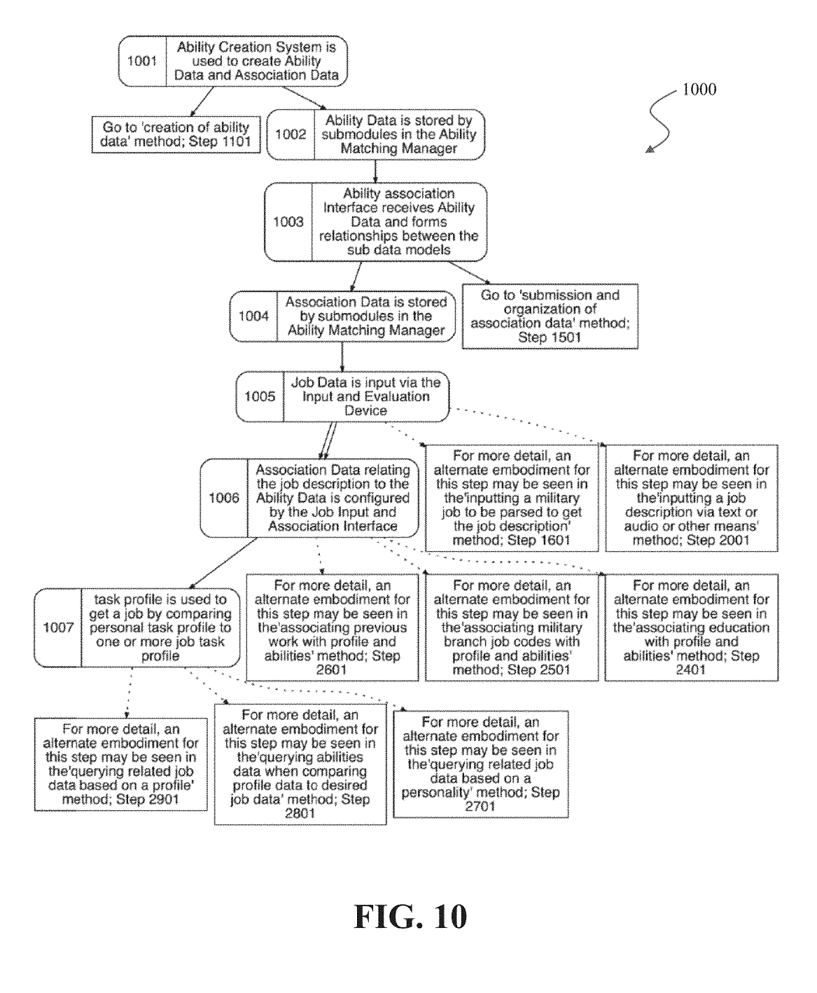

Referring now to FIGS. 10-29, one or more methods and processes for using ability name system 500 for creating, analyzing and matching ability data with jobs and profiles data are described and shown schematically in detail. As described above, ability matching system 500 and the one or more processed described below (and shown in FIGS. 10-29) can be incorporated within overall system 100 and overall process 200 for allowing client-employers for identify qualified candidates for new job positions and for allowing client-candidates identify job positions for which they are qualified.

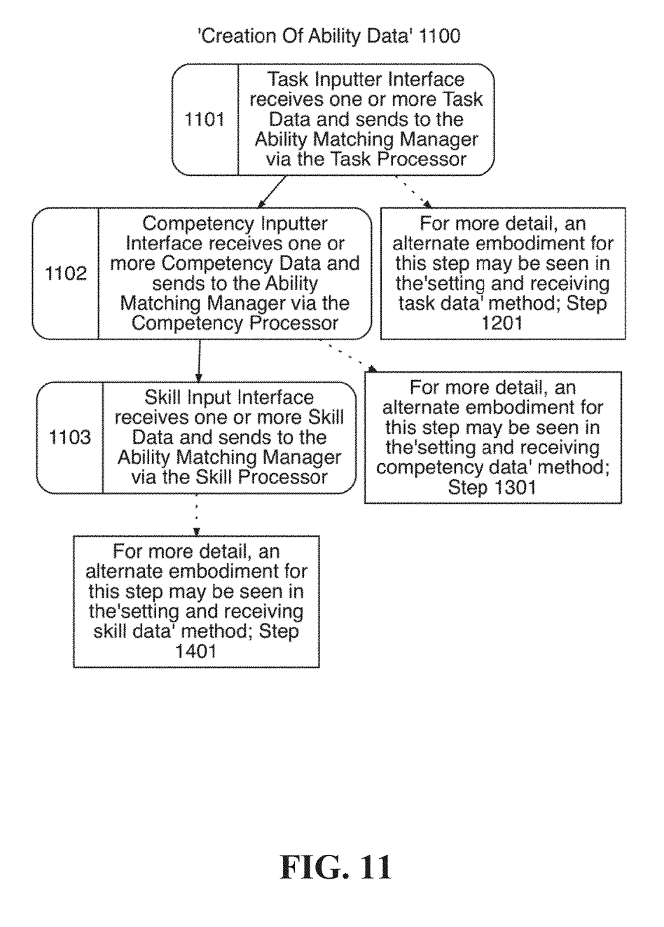

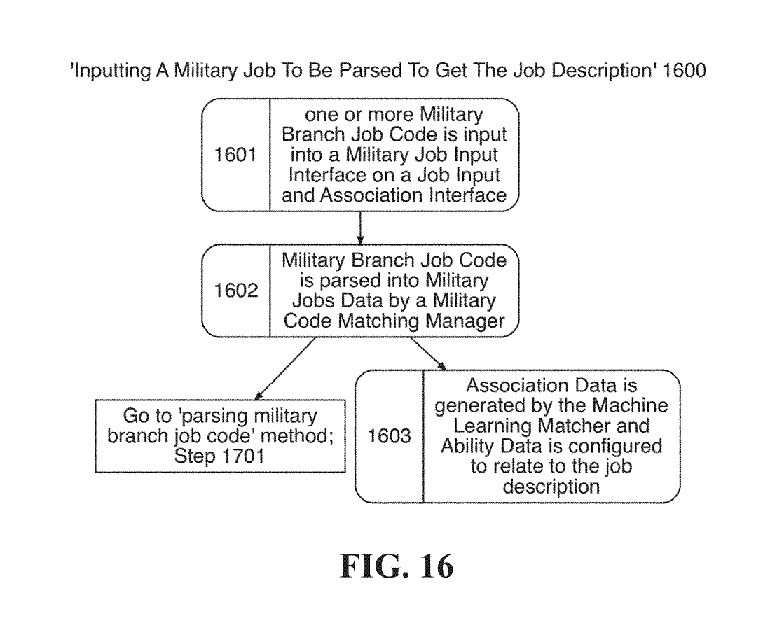

Referring to FIG. 10, an overall ability matching method or process 1000 representing the methods and steps for using ability matching system 500 according to one embodiment is shown schematically as a flow chart. Ability matching process 1000 can begin at a step 1001 where ability creation system 524 can be used to create ability data 503 and association data 544. The creation of ability data occurring at step 1001 can also include one or more sub-step or intermediate steps represented by method 1100, as well as methods 1200, 1300 and 1400, as illustrated in FIGS. 11-14 and described in greater detail below. Following the creation of ability data at step 1001, at step 1002, the created ability data 503 can be stored by submodules in the ability matching manager 501. Next, at step 1003, ability association interface 543 can receive the created ability data 503 and can form relationships between the sub data models. Step 1003 can further additional sub-steps or intermediate steps for the submission and organization of data through a method 1500 as described in greater detail below and shown in FIG. 15. Next, at step 1004, the association data 544 can be stored by submodules in the ability matching manager 501.

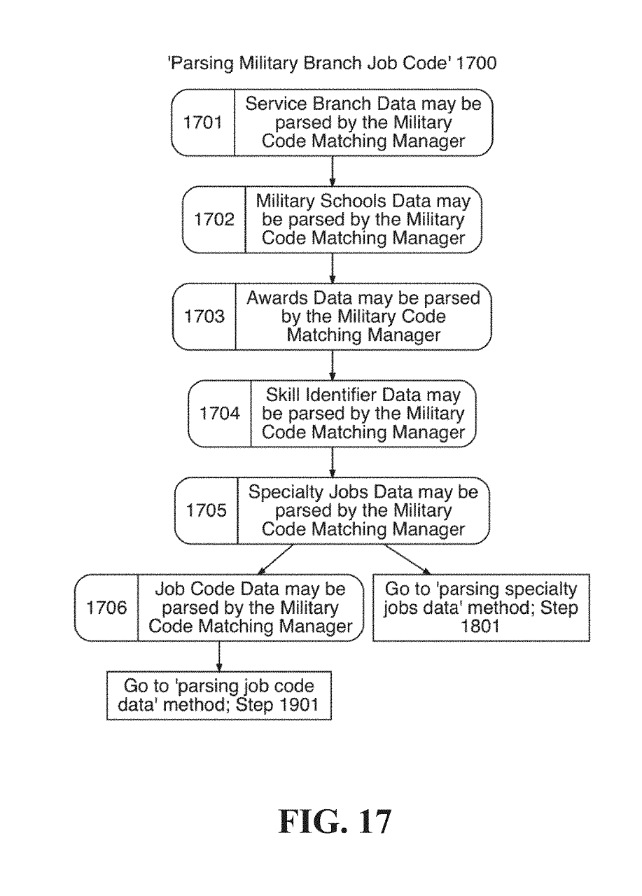

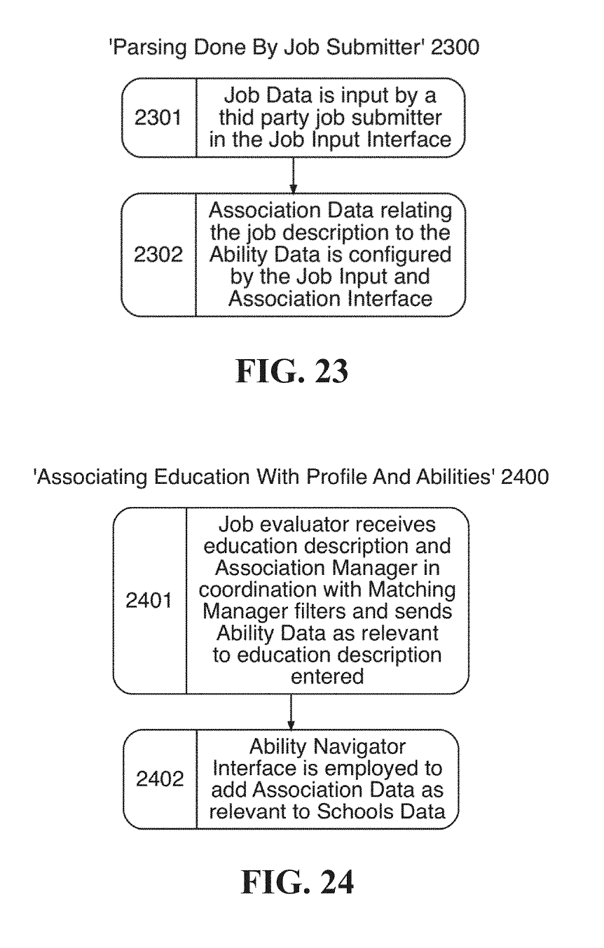

Next, at step 1005, job data 516 can be input via the input and evaluation device 523. In an alternative embodiment, step 1005 may include additional sub-steps utilized in connection with a method 1600 for inputting a military job to be parsed to get the job description as shown in FIG. 16 and described below. It is also recognized that other methods similar to method 1600 can be employed for other industry/occupation/field specific jobs in certain embodiments of the invention. In addition, according to another alternative embodiment, step 1005 may include additional sub-steps utilized in connection with a method 2000 for the inputting of a job description via text or audio or other means as shown in FIG. 20 and described below.

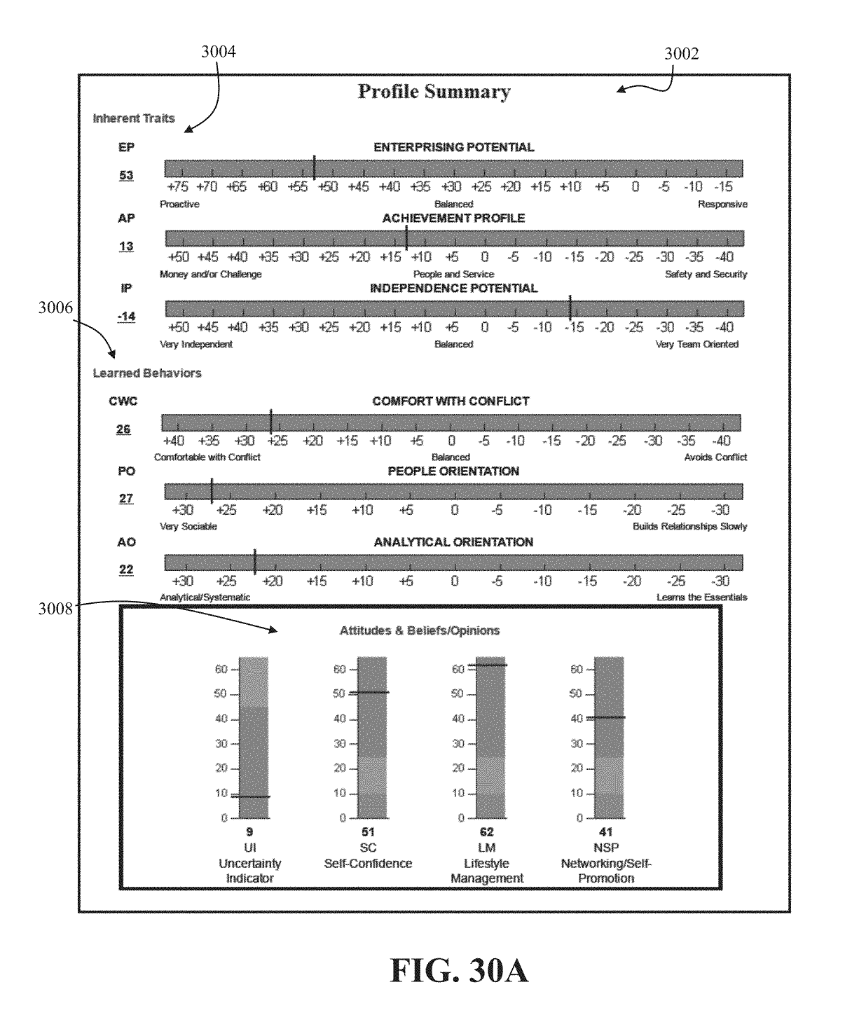

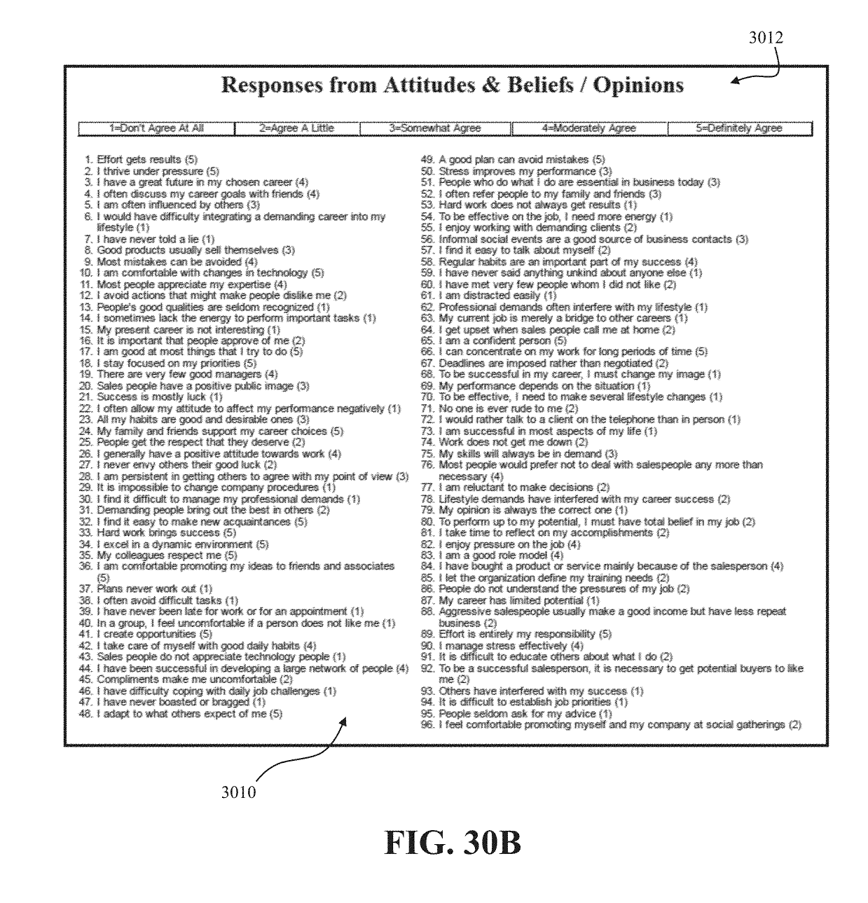

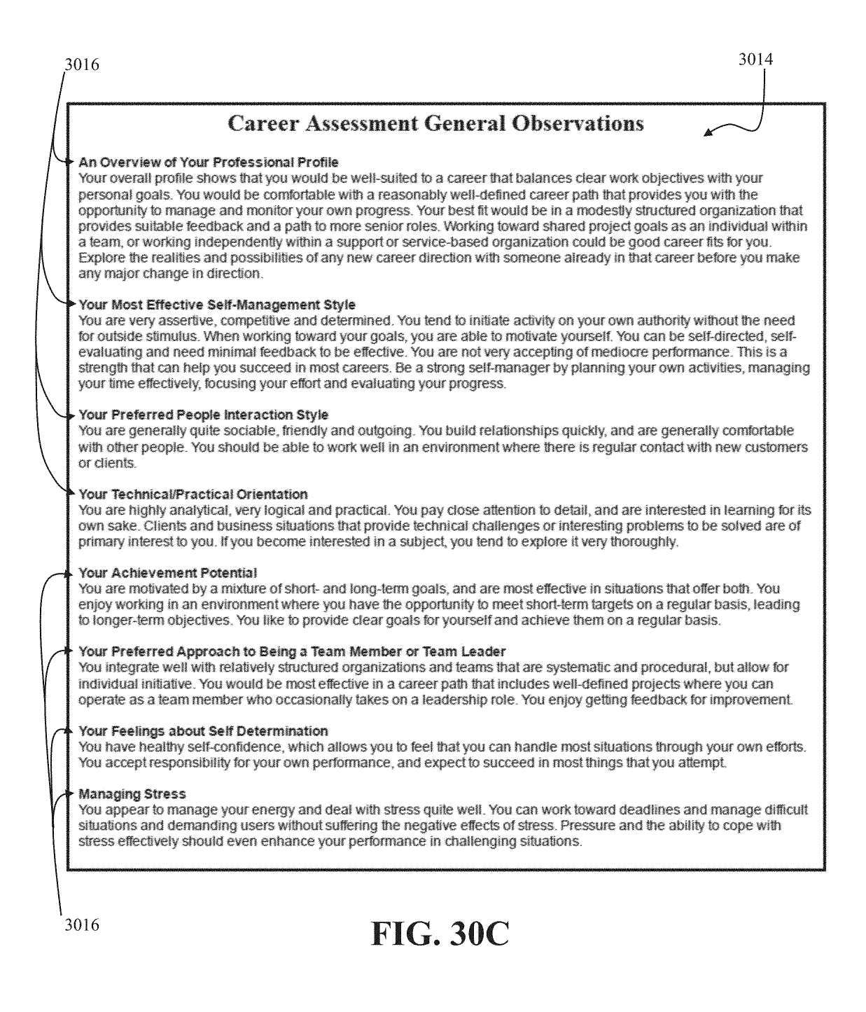

Next, at step 1006, the association data 544 relating the job description to the ability data 503 can be configured by the job input and association interface 604. In an alternative embodiment, step 1006 may include additional sub-steps or intermediate steps utilized in connection with a method 2600 for associating previous work with profile and abilities as shown in FIG. 26 and described below. In addition, according to another alternative embodiment, step 1006 may include additional sub-steps utilized in connection with a method 2400 for associating education data with a profile and abilities data as shown in FIG. 24 and described below. In addition, according to yet another alternative embodiment, step 1006 may include additional sub-steps utilized in connection with a method 2500 for associating military branch job codes (or other specific industry, occupation or field job codes) with a profile and abilities data as shown in FIG. 25.

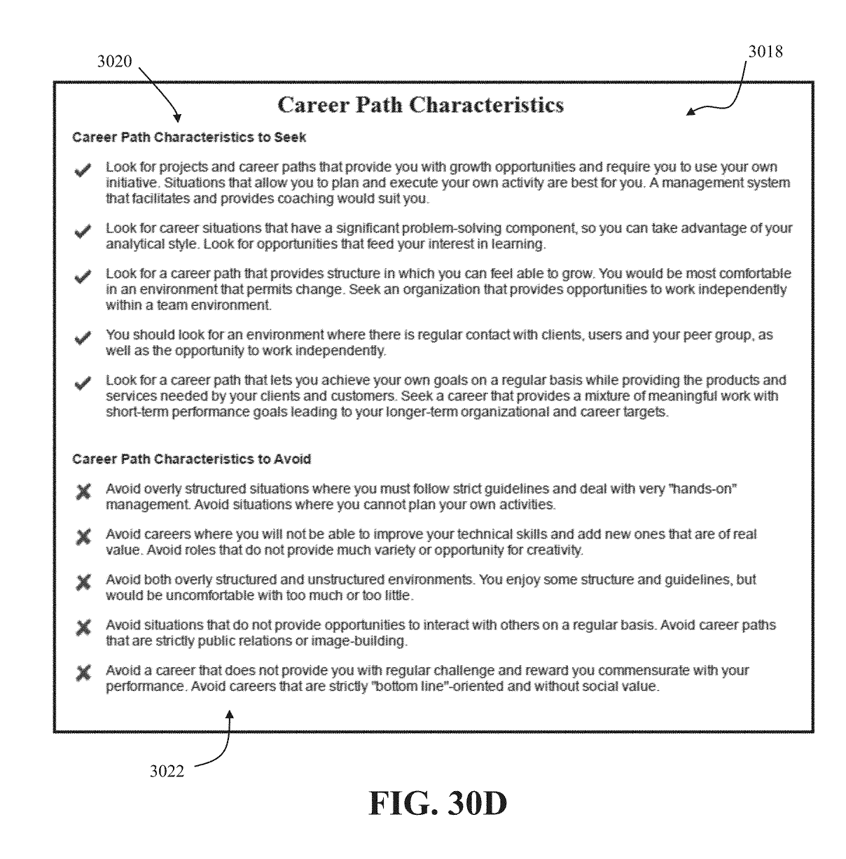

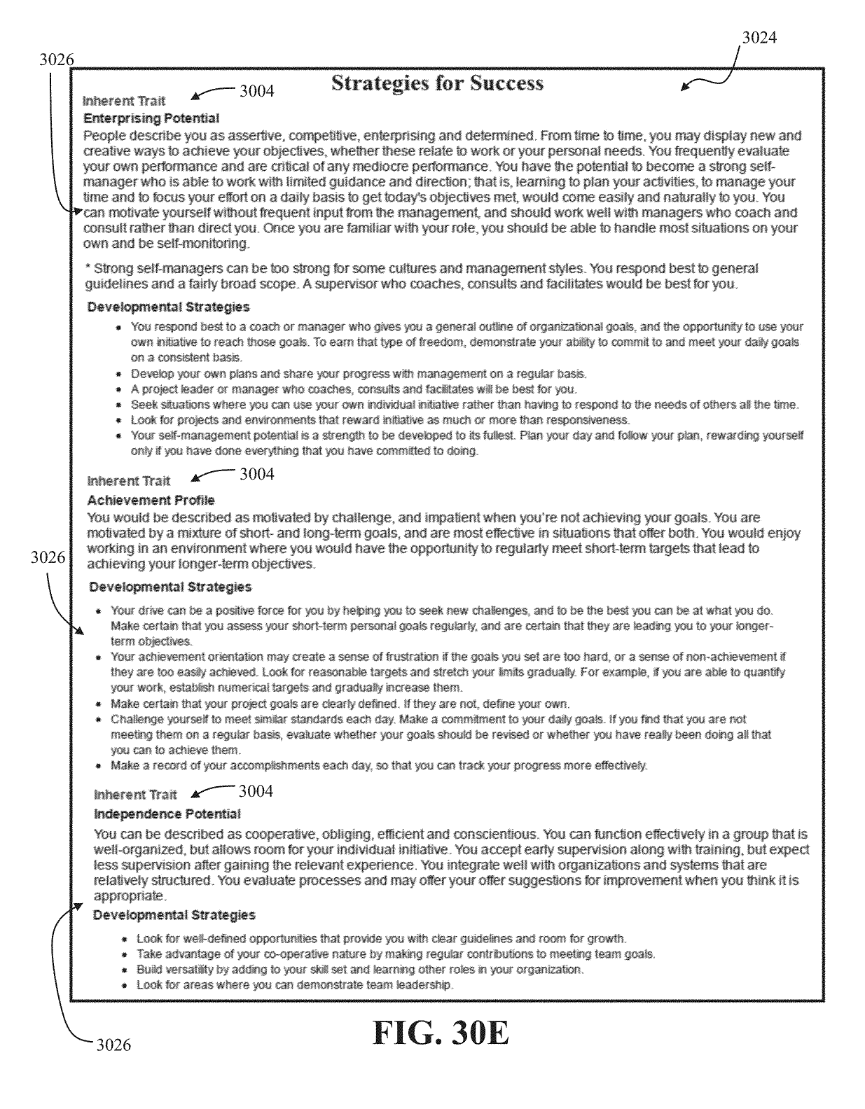

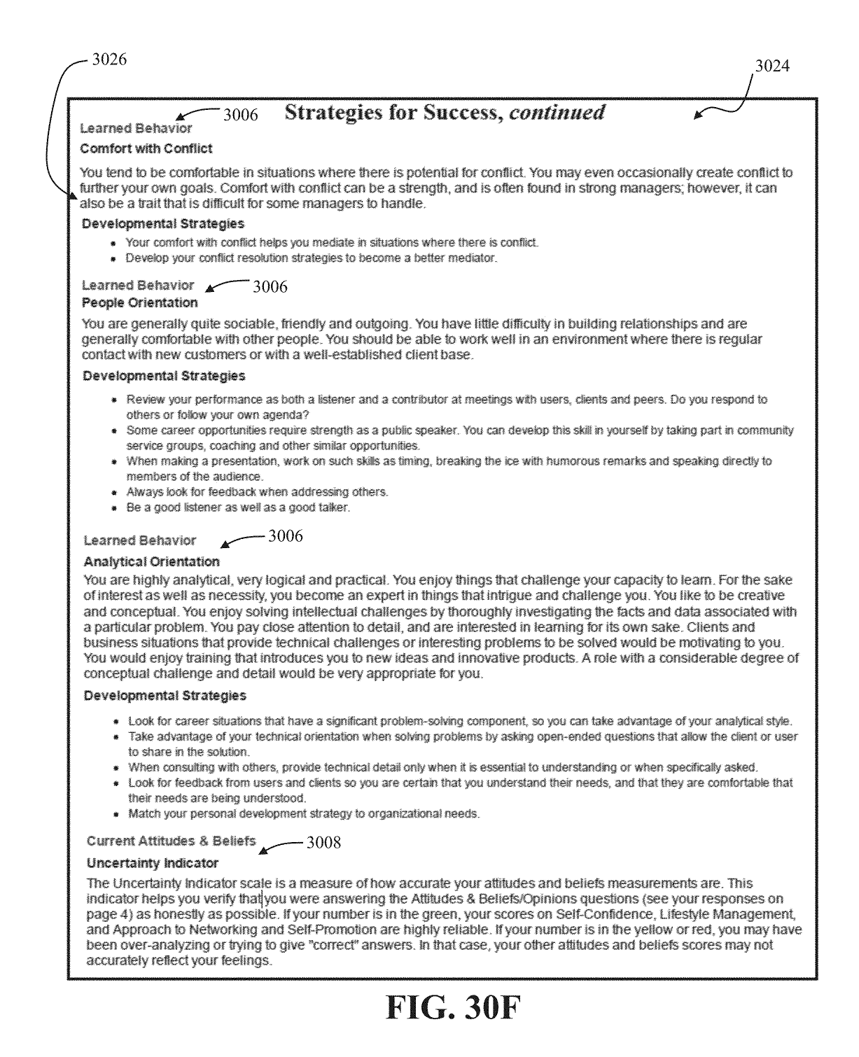

Next, at step 1007, a task profile can be used to identify a job position by comparing personal task profile to one or more job task profiles. In an alternative embodiment, step 1007 may include additional sub-steps utilized in connection with a method 2900 for querying related job data based on a profile as shown in FIG. 29 and described below. In addition, in another alternative embodiment, step 1007 may include additional sub-steps utilized in connection with a method 2700 for querying related job data based on a personality method as shown in FIG. 27 and described below. In addition, in yet another alternative embodiment, step 1007 may include additional sub-steps utilized in connection with a method 2800 for querying abilities data when comparing profile data to desired job data as shown in FIG. 28 and described below.

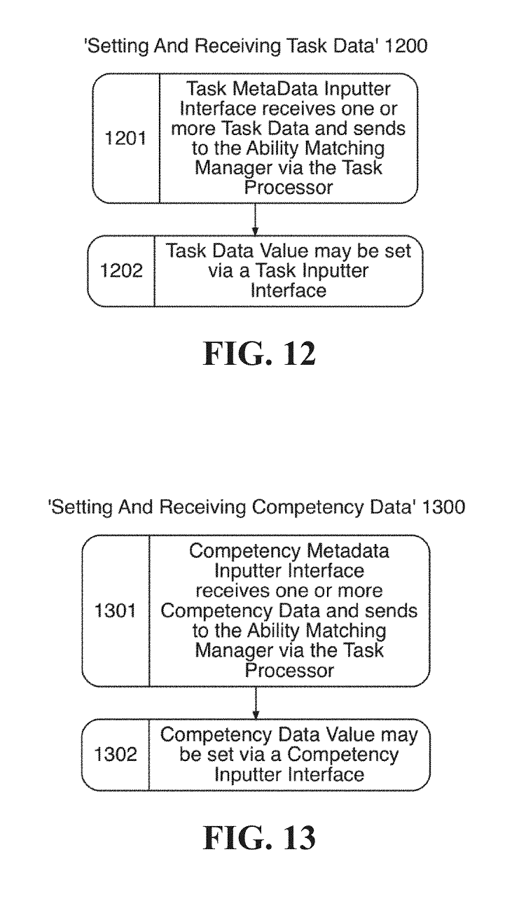

Referring now to FIG. 11, a schematic flow chart for method 1100 for the creation of ability data according to one embodiment of the present invention is shown and described. As shown in FIG. 11, method 1100 can be utilized as additional sub-steps or intermediate steps in system 1000 during step 1001. In a first step 1101, the task inputter interface 526 can receive one or more task data 505 and can send to the ability matching manager 501 via the task processor 539. In an alternative embodiment, step 1101 may include additional sub-steps utilized in connection with a method 1200 for setting and receiving task data as shown in FIG. 12 and described below.

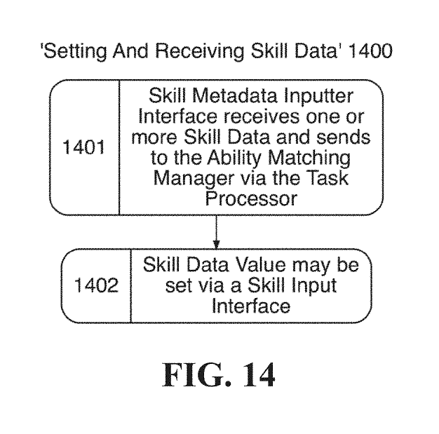

Next, at step 1102, the competency inputter interface 529 can receive one or more competency data 506 and can send the competency data 506 to the ability matching manager 501 via the competency processor 538. In an alternative embodiment, step 1102 may include additional sub-steps utilized in connection with a method 1300 for setting and receiving competency data as shown in FIG. 13 and described below.

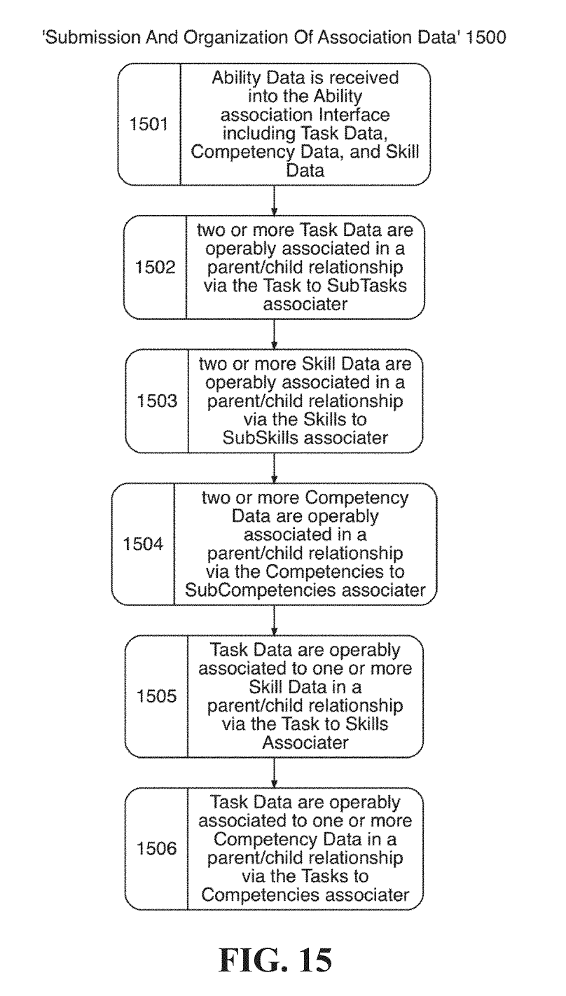

Next, at step 1103, the skill input interface 530 can receive one or more skill data 504 and can send the skill data 504 to the ability matching manager 501 via the skill processor 537. In an alternative embodiment, step 1103 may include additional sub-steps utilized in connection with a method 1400 for setting and receiving skill data as shown in FIG. 14 and described below.

Referring now to FIG. 12, a schematic flow chart for method 1200 for setting and receiving task data in accordance with one embodiment is shown and described. As described above, method 1200 can be incorporated into step 1101 for the creation of ability data in method 1100. As shown in FIG. 12, in a first step 1201, the task metadata inputter interface 527 can receive one or more task data 505 and can send the task data 505 to the ability matching manager 501 via the task processor 539. Next, at a step 1202, a task data value may be set via a task inputter interface 526 for the task data 505.

Referring now to FIG. 13, a schematic flow chart for method 1300 for setting and receiving competency data in accordance with one embodiment is shown and described. As described above, method 1300 can be incorporated into step 1102 for the creation of ability data in method 1100. As shown in FIG. 13, in a first step 1301, the competency metadata inputter interface 528 can receive one or more competency data 506 and sends the competency data 506 to the ability matching manager 501 via the task processor 539. Next, at a step 1302, a competency data value may be set via a competency inputter interface 529 for the competency data 506.

Referring now to FIG. 14, a schematic flow chart for method 1400 for setting and receiving skill data in accordance with one embodiment is shown and described. As described above, method 1400 can be incorporated into step 1103 for the creation of ability data in method 1100. As shown in FIG. 14, in a first step 1401, the skill metadata inputter interface 531 can receive one or more skill data 504 and can send the skill data 504 to the ability matching manager 501 via the task processor 539. Next, at a step 1402, a skill data value may be set via a skill input interface 530 for the skill data 504.

Referring now to FIG. 15, a schematic flow chart for method 1500 for the submission and organization of association data in accordance with one embodiment is shown and described. As described above, method 1500 can be incorporated into step 1003 for forming relationships between ability data sub data modules as part of overall method 1000. As shown in FIG. 15, in a first step 1501, ability data 503 can be received into the ability association interface 543 including task data 505, competency data 506, and skill data 504. Next, at step 1502, two or more task data 505 are operably associated in a parent/child relationship via the task to subtasks associater 532. Next, at step 1503, two or more skill data 504 are operably associated in a parent/child relationship via the skills to subskills associater 533. Next, at step 1504, two or more competency data 506 are operably associated in a parent/child relationship via the competencies to subcompetencies associater 534. Next, at a step 1505, task data 505 are operably associated to one or more skill data 504 in a parent/child relationship via the task to skills associater 536. Next, at step 1506, task data 505 are operably associated to one or more competency data 506 in a parent/child relationship via the tasks to competencies associater 535.

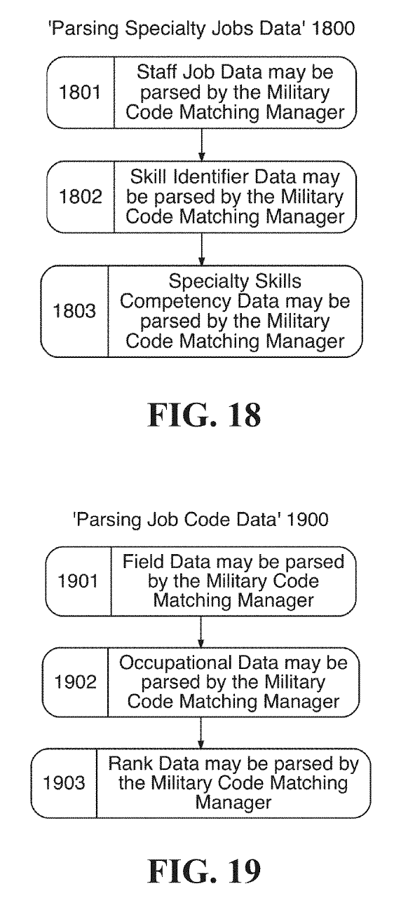

Referring now to FIG. 16, a schematic flow chart for method 1600 for inputting a military job (or other industry, occupation or field specific job) to be parsed to get a job description in accordance with one embodiment is shown and described. As described previously, while method 1600 references specific job type (military), the steps and processes can be suitably be applied to any type of industry, occupation of field specific job type or position. In addition, as described above, method 1600 can be incorporated into step 1005 for inputting job data in connection with overall method 1000. As shown in FIG. 16, in a first step 1601, one or more military branch job code is input into a military job input interface 605 on a job input and association interface 604. Next, at a step 1602, military branch job code is parsed into military jobs data 514 by a military code matching manager 910. As shown in FIG. 16, step 1602 may include additional sub-steps utilized in connection with a method 1700 for parsing a military brand job code as shown in FIG. 17 and described below. Next, at step 1603, association data 544 is generated by the machine learning matcher 911 and ability data 503 is configured to relate to the job description.

Referring now to FIG. 17, a schematic flow chart for method 1700 for parsing military branch job code according to one embodiment is shown and described. As described above, method 1700 can be incorporated into step 1602 for parsing military branch job codes during method 1600. In addition, while method 1700 refers specifically to military-related jobs, it is recognized that method 1700 can be adapted for use with any other type of industry, occupation of field specific job.

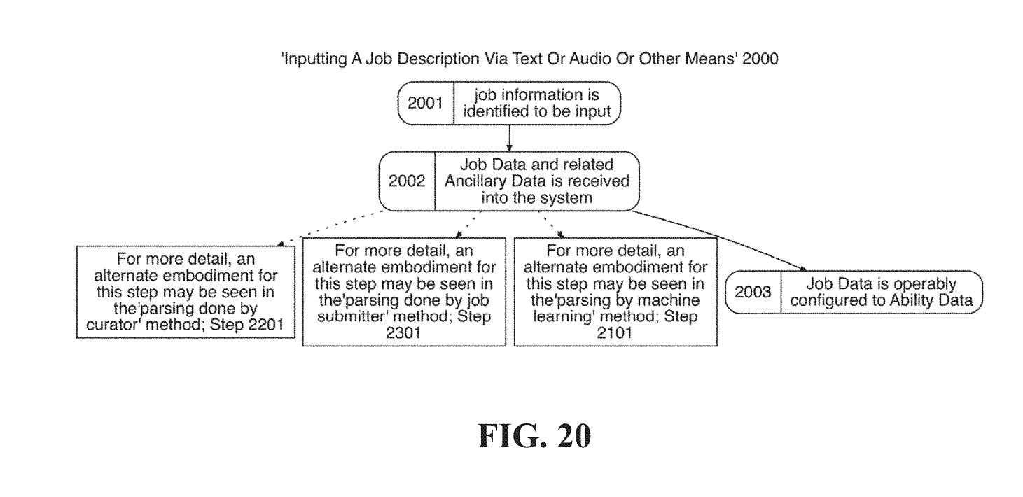

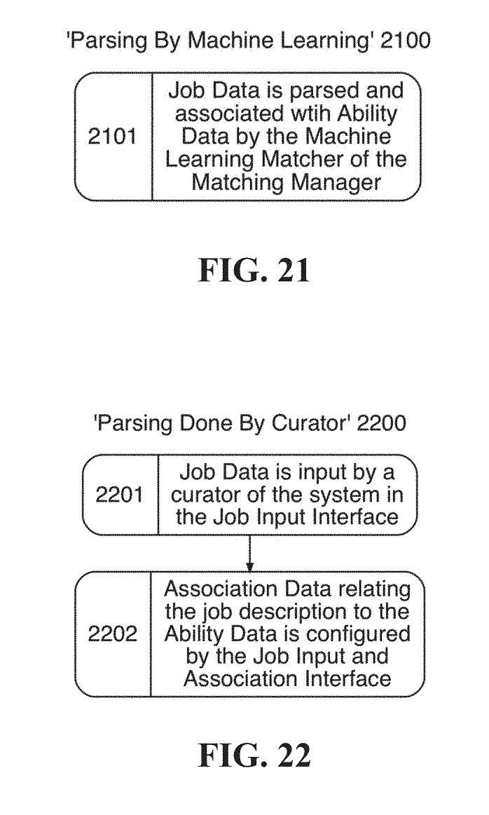

As shown in FIG. 17, in a first step 1701, service branch data 903 may be parsed by the military code matching manager 910. Next, at a step 1702, military schools data 902 may be parsed by the military code matching manager 910. Next, at step 1703, awards data 901 may be parsed by the military code matching manager 910. Next, at step 1704, skill identifier data 907 may be parsed by the military code matching manager 910. Next, at step 1705, specialty jobs data 906 may be parsed by the military code matching manager 910. As shown in FIG. 17, step 1705 can also incorporate additional sub-steps utilized in connection with a method 1800 for parsing specialty jobs data as shown in FIG. 18 and described below. Next, at step 1706, job code data 912 may be parsed by the military code matching manager 910. As also shown in FIG. 17, step 1706 can also incorporate additional sub-steps utilized in connection with a method 1900 for parsing job code data as shown in FIG. 19 and described below.

Referring now to FIG. 18, a schematic flow chart for method 1800 for parsing specialty jobs data according to one embodiment is shown and described. As described above, method 1800 can be incorporated into step 1705 of method 1700 for parsing military branch job codes (or other industry, occupation or field specific job codes). As shown in FIG. 18, in a first step 1801, staff job data 908 may be parsed by the military code matching manager 910. Next, at step 1802, skill identifier data 907 may be parsed by the military code matching manager 910. Next, at step 1803, specialty skills competency data 909 may be parsed by the military code matching manager 910.

Referring now to FIG. 19, a schematic flow chart for method 1900 for parsing job code data according to one embodiment is shown and described. As described above, method 1900 can be incorporated into step 1706 of method 1700 for parsing military branch job codes (or other industry, occupation or field specific job codes). As shown in FIG. 19, method 1900 can begin at step 1901 where field data 913 may be parsed by the military code matching manager 910. Next, at step 1902, occupational data 904 may be parsed by the military code matching manager 910. Next, at step 1903, rank data 905 may be parsed by the military code matching manager 910.

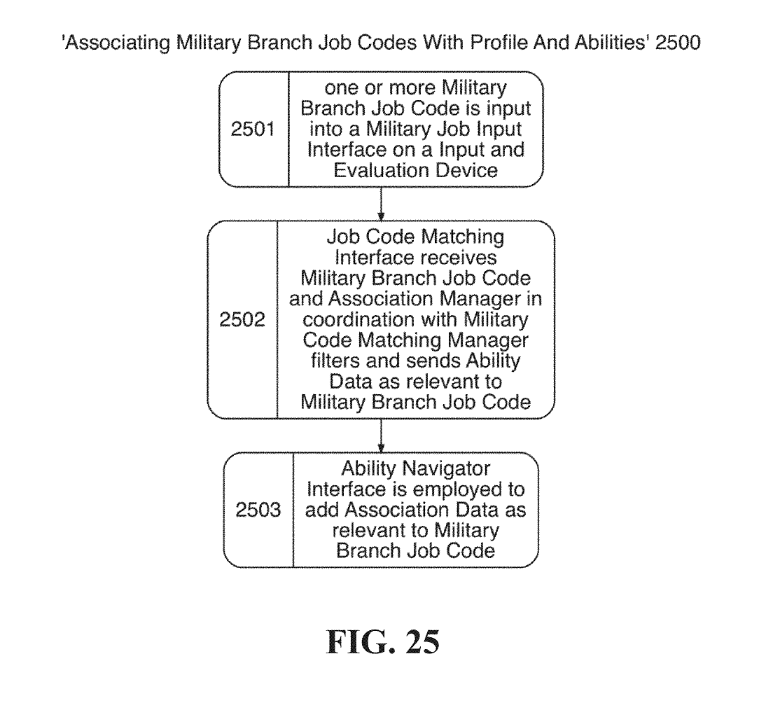

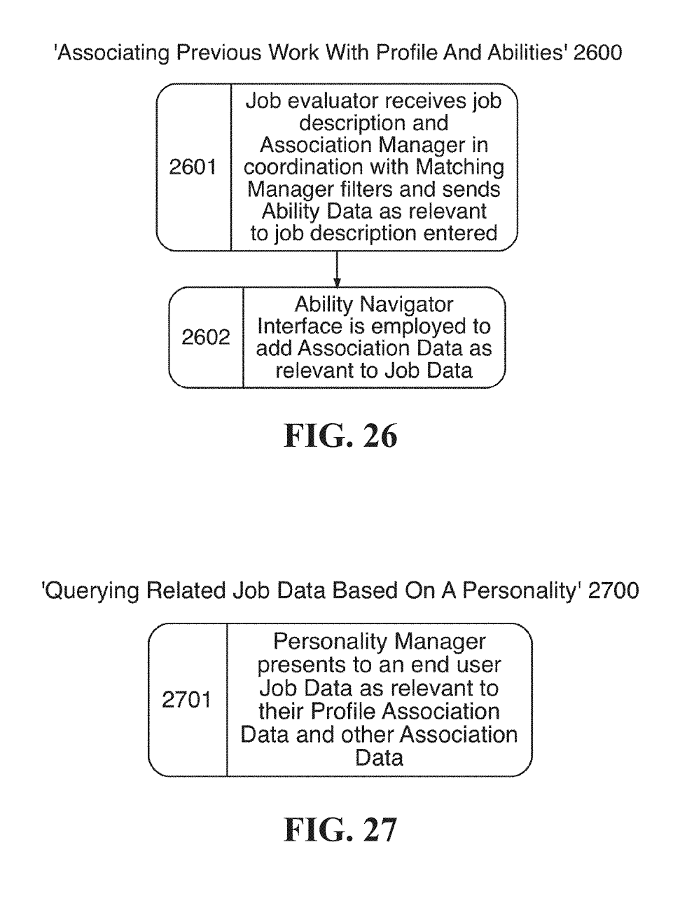

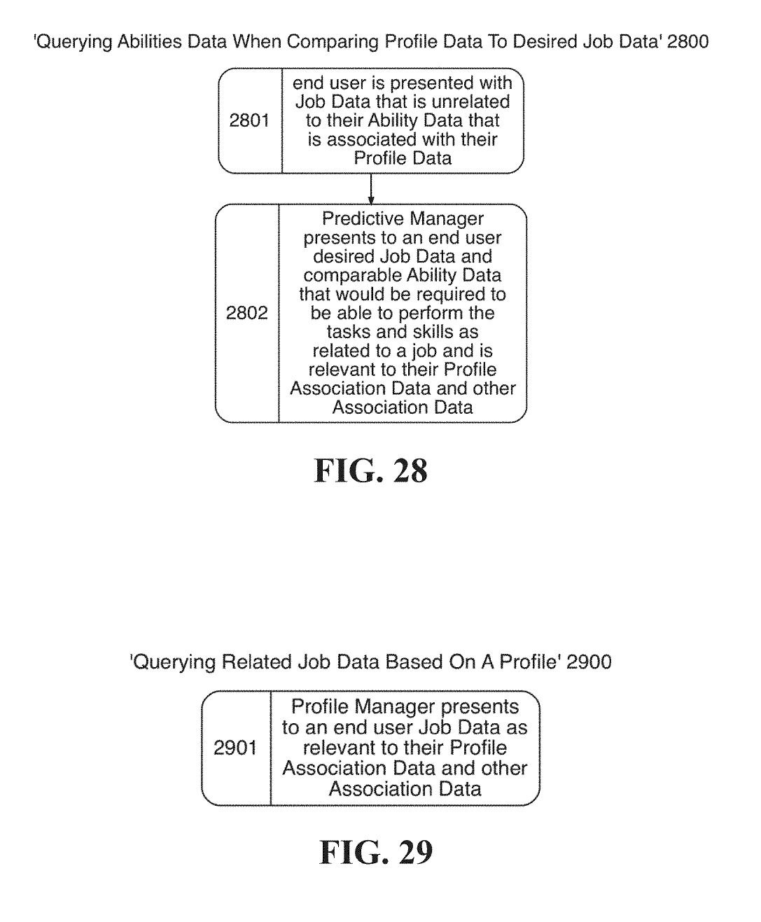

Referring now to FIG. 20, a schematic flow chart for method 2000 for inputting a job description via text or audio or other means according to one embodiment is shown and described. As described above, method 2000 may be incorporated into step 1005 for inputting job data as part of overall method 1000. As shown in FIG. 20, method 2000 can begin at step 2001 where job information is identified to be input. Next, at step 2002, job data 516 and related ancillary data 517 is received into the ability matching system 500. In an alternative embodiment, step 2002 may include additional sub-steps utilized in connection with a method 2100 for parsing done by a machine learning module as shown in FIG. 21 and described below. In addition, in another alternative embodiment, step 2002 may include additional sub-steps utilized in connection with a method 2200 for parsing done by a curator module as shown in FIG. 22 and described below. In addition, in yet another alternative embodiment, step 2002 may include additional sub-steps utilized in connection with a method 2300 for parsing done by a job submitter module as shown in FIG. 23 and described below. Following step 2202, at step 2203, job data 516 is operably configured to ability data 503.

Referring now to FIG. 21, a schematic flow chart for method 2100 for parsing job data through machine learning according to one embodiment is shown and described. As described above, method 2100 can be incorporated into step 2002 of method 2000 in order to receive job data. As shown in FIG. 21, method 2100 can include step 2101 where job data 516 is parsed and associated with ability data 503 by the machine learning matcher 911 of the matching manager 521 of ability matching system 500.

Referring now to FIG. 22, a schematic flow chart for method 2200 for parsing job data through a curator according to one embodiment is shown and described. As described above, method 2200 can be incorporated into step 2002 of method 2000 in order to receive job data. As shown in FIG. 22, method 2200 can begin at step 2201 where job data 516 is input by a curator of the system in the job input interface 606. Next, at step 2202, association data 544 relating the job description to the ability data 503 is configured by the job input and association interface 604.

Referring now to FIG. 23, a schematic flow chart for method 2300 for parsing job data through a job submitter according to one embodiment is shown and described. As described above, method 2300 can be incorporated into step 2002 of method 2000 in order to receive job data. As shown in FIG. 23, method 2300 can begin at step 2301 where job data 516 is input by a third party job submitter in the job input interface 606. Next, at step 2302, association data 544 relating the job description to the ability data 503 is configured by the job input and association interface 604.

Referring now to FIG. 24, a schematic flow chart for method 2400 for associating education data with a profile and abilities data according to one embodiment is shown and described. As described above, method 2400 can be incorporated into step 1006 of overall method 1000 in order to relate a job description to ability data. As shown in FIG. 24, method 2400 can begin at step 2401 where job evaluator 703 receives education description and association manager 508 in coordination with matching manager 521 filters and sends ability data 503 as relevant to an education description entered. Next, at step 2402, the ability navigator interface 608 is employed to add association data 544 as relevant to schools data 520.

Referring now to FIG. 25, a schematic flow chart for method 2500 for associating military branch job codes with a profile and abilities according to one embodiment is shown and described. As described above, method 2500 can be incorporated into step 1006 of overall method 1000 in order to relate a job description to ability data. In addition, while method 2500 refers specifically to military job data, it is recognized that method 2500 can also be adapted for use with other industry, occupation of field specific job data. As shown in FIG. 25, method 2500 can begin at step 2501 where one or more military branch job code (or other industry, occupation or field specific job code) is input into a military job input interface 605 on an input and evaluation device 523. Next, at step 2502, job code matching interface 702 receives military branch job code and association manager 508 in coordination with military code matching manager 910 filters and sends ability data 503 as relevant to military branch job code. Next, at step 2503, ability navigator interface 608 is employed to add association data 544 as relevant to military branch job code.

Referring now to FIG. 26, a schematic flow chart for method 2600 for associating previous work with a profile and abilities according to one embodiment is shown and described. As described above, method 2600 can be incorporated into step 1006 of overall method 1000 in order to relate a job description to ability data. As shown in FIG. 26, method 2600 can begin at step 2601 where job evaluator 703 receives job description and association manager 508 in coordination with matching manager 521 filters and sends ability data 503 as relevant to job description entered. Next, at step 2602, ability navigator interface 608 is employed to add association data 544 as relevant to job data 516.

Referring now to FIG. 27, a schematic flow chart for method 2700 for querying related job data based on a personality according to one embodiment is shown and described. As described above, method 2700 can be incorporated into step 1007 of overall method 1000 in order to identify a job position by comparing a personal task profile to one or more job task profiles. As shown in FIG. 27, method 2700 can include step 2701 where personality manager 510 presents to an end user job data 516 as relevant to their profile association data 518 and other association data 544.

Referring now to FIG. 28, a schematic flow chart for method 2800 for querying abilities data when comparing profile data to desired job data is shown and described. As described above, method 2800 can be incorporated into step 1007 of overall method 1000 in order to identify a job position by comparing a personal task profile to one or more job task profiles. As shown in FIG. 28, method 2800 can begin at step 2801 where an end user is presented with job data 516 that is unrelated to their ability data 503 that is associated with their profile data 540. Next, at step 2802, the predictive manager 509 presents to an end user desired job data 516 and comparable ability data 503 that would be required to be able to perform the tasks and skills as related to a job and is relevant to their profile association data 518 and other association data 544.

Referring now to FIG. 29, a schematic flow chart for method 2900 for querying related job data based on a profile according to one embodiment is shown and described. As described above, method 2900 can be incorporated into step 1007 of overall method 1000 in order to identify a job position by comparing a personal task profile to one or more job task profiles. As shown in FIG. 29, method 2900 can include step 2901 where the profile manager 511 presents to an end user job data 516 as relevant to their profile association data 518 and other association data 544.

Referring now to FIGS. 30A-30G, an exemplary embodiment of a career choice GPS assessment report generated by system 100 (and through process 200) is shown in described. As described above, the career choice assessment report can analyze resume data, work experience data and personality assessment data provided by the client-candidate to identify traits, characteristics and abilities of a client-candidate to assist the client-candidate in assessing career choices and goals. According to one embodiment, the personality data received by system 100 can include answers/responses to a set of personality assessment questions and/or statements, which can processed and analyzed using one or more defined algorithms to identify candidate personality data relating to learned traits, inherent behaviors, attitudes, beliefs and fit scores associated with specific job types and positions. FIGS. 30A-30G illustrate an exemplary career choice assessment report according to one embodiment of the present invention displaying the analyzed personality and candidate data in order to assist and assess a client-candidate.

As shown in FIG. 30A, the career choice assessment report can include a profile summary 3002 identifying certain inherent traits 3004, learned behaviors 3006, and attitudes and beliefs/opinions 3008 of the client-candidate based on the analyzed personality data and/or candidate data. According to one embodiment traits 3004, behaviors 3006 and attitudes and beliefs/opinions 3008 can be created using a set of personality assessment questions/statements 3010 as illustrated in FIG. 30B. As shown in FIG. 30A, the career assessment report profile summary 3002 can display inherent traits 3002 as an enterprising potential trait, an achievement profile trait and an independence potential trait. As further shown in FIG. 30A, the career assessment report profile summary 3002 can display learned behaviors 3004 as a comfort with conflict behavior, a people orientation behavior and an analytical orientation behavior. As further shown in FIG. 30A, the career assessment report profile summary 3002 can display attitudes and beliefs/opinions 3008 as an uncertainty indicator, a self-confidence indicator, a lifestyle management indicator and a networking/self-promotion indicator.

As shown in FIG. 30B, the career choice assessment report can include a response summary 3012 displaying the set of personality assessment questions/statements 3010 used to create the personality data utilized by the assessment report. The questions/statements illustrated in FIG. 30B represent just one exemplary set of personality assessment questions/statements 3010 and it is recognized that any number of different questions/statements can be used in alternative embodiments.

As shown in FIG. 30C, the career choice assessment report can include a career assessment general observations summary 3014 that can include individualized summaries 3016 of one or more traits 3004, behaviors 3006, attitudes and beliefs/opinions 3008 and other attributes based on the analyzed personality and candidate data to assist a candidate selecting a career path most suitable to the candidates traits 3004, behaviors 3006, attitudes 3008 and other attributes. Each individualized summary 3016 can include one or more pre-defined sentences describing and summarizing a certain attribute 3004-3008 based on the candidate's analyzed personality data and candidate data. According to one embodiment, the pre-defined sentences comprising each individualized summary 3016 can be selected by system 100 based in part on the candidate's answers to the set of personality assessment questions/statements 3010 illustrated in FIG. 30B.

As shown in FIG. 30D, the career choice assessment report can include a career path characteristics summary 3018 that can provide career path characteristics to seek 3020 and career path characteristics to avoid 3022 based on the identified one or more traits 3004, behaviors 3006, attitudes and beliefs/opinions 3008 and other attributes for the candidate and/or the candidate's personality data and other candidate data analyzed by system 100. Each career path characteristics to seek 3020 and career path characteristics to avoid 3022 can comprise pre-defined short summaries highlighting a career path characteristic relevant to the candidate based on the analyzed personality data and other candidate data (including attributes 3004-3008) and whether to seek or avoid careers having a strong association with that characteristic. According to one embodiment, characteristics 3020 and 3022 can be selected by system 100 based on one or more modules and/or algorithms configured to associate known characteristics to job types and career types.

As shown in FIGS. 30E-30G, the career choice assessment report can include a strategies for success summary 3024 that can include strategic summaries 3026 for one or more inherent traits 3004, learned behaviors 3006, and attitude and beliefs/opinions 3008 and can correspond to such traits 3004, behaviors 3006 and attitudes 3008 as displayed on the career assessment report profile summary 3002 (shown on FIG. 30A). Each strategic summary 3026 can comprise a pre-defined summary of a specific trait 3004, behavior 3006 or attitude 3008 and can be selected by system 100 based on the candidate's score for the specific trait 3004, behavior 3006 or attitude 3008. For example, as shown in FIG. 30A, the candidate assessed had a comfort with conflict score of 26 for the comfort with conflict learned behavior 3006, which can correspond to a positive comfort with conflict level, causing the pre-defined strategic summary 3026 for the comfort with conflict to be provided on the strategies for success summary 3024 as shown in FIG. 30F. As further shown in FIGS. 30E-30G, each strategic summary 3026 can additionally include a developmental strategies sub-section 3028, which can identify pre-defined strategies associated with the candidate's score for the corresponding trait 3004, behavior 3006 or attitude 3008 (as shown in FIG. 30A) and selected by system 100.

With reference to the several figures and foregoing description, the elements defined as competency metadata, task metadata, skill metadata, competency data value, skill data value and task data value can be considered important for the working functionality, but do not appear in the drawings and are described now for reference. Competency metadata can comprise data or data objects related to competency data 506. Task metadata can comprise a data or data objects related to task data 505. Skill metadata can comprise a data or data objects related to skill data 504. Competency data value can comprise one or more ranges, scalar or vector values that indicate a range for competency data 506. In some embodiments of the present invention, it can be recognized that if competency data value is absent, then there may be string values or other means for indicating competency values. Skill data value can comprise one or more ranges, scalar, or vector values that indicate a range for skill data 504. In some embodiments of the present invention, it can be recognized that if skill data value is absent, then there may be string values or other means for indicating skills values. Task data value can comprise one or more ranges, scalar, or vector values that indicate a range for task data 505. In some embodiments of the present invention, it can be recognized that if task data value is absent, then there may be string values or other means for indicating task values

From the foregoing, it will be seen that this invention is one well adapted to attain all the ends and objects hereinabove set forth together with other advantages which are obvious and which are inherent to the structure. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

1. A job matching system for matching qualified candidates to available job positions, said system comprising:
a database module for storing candidate profile data for one or more candidates, job data for one or more job positions created by one or more employers, and abilities data relating to said candidate profile data and said job application data;
a user interface configured for allowing candidates to input candidate profile data relating to a candidate profile and for employers to input job data relating to a job profile;
an analysis module configured for analyzing said candidate profile data and said job profile data; and
a program application comprising instructions tangibly stored on a computer-readable medium and executable by a computer process to perform the steps of:
receiving job data associated with a job position from an employer, said job data comprising job description data;
analyzing said job data through said analysis module to identify abilities data associated with said job position, said abilities data comprising skills data associated with candidate skills required for said job position as identified in said job data;
creating a job profile for said job position, said job profile containing said abilities data associated with said job position;
analyzing said job data through said analysis module to compare said abilities data associated with said job position to abilities data associated with one or more candidate profiles stored in said database module; and
identifying one or more qualified candidates for said job position based on a matching of said abilities data associated with said job position and said abilities data associated with said one or more candidate profiles.

2. The system of claim 1, wherein said analysis module comprises:
a natural language processing module;
a data validation module; and
an abilities matching module.

3. The system of claim 1, wherein said program instructions of said program application further comprises steps for generating a candidate pool analysis report including said one or more qualified candidates and providing said candidate pool analysis report to said employer of said job position through said user interface.

4. The system of claim 3, wherein said analysis module comprises a CPA report generator module configured to analyzing said candidate profiles of said one or more qualified candidates and generating a ranked list of said one or more qualified candidates based on said matching of abilities data.

5. The system of claim 1, wherein said program instructions of said program application further comprises steps for:
receiving candidate profile data from a candidate, said candidate profile data comprising resume data containing information related to said candidate's work history, education and abilities;
analyzing said candidate profile data through said analysis module to identify abilities data associated with said candidate profile data, said abilities data comprising skills data associated with skills associated with said resume data provided by said candidate;
creating a candidate profile from said candidate profile data, said candidate profile containing said abilities data associated with said resume data; and
storing said candidate profile in said database module.

6. The system of claim 5, wherein said program instructions of said program application further comprises steps for:
analyzing said candidate profile through said analysis module to compare said abilities data associated with said candidate profile to abilities data associated with one or more job profiles stored in said database module; and
identifying one or more qualified job positions based on a matching of said abilities data associated with said candidate profile and said abilities data associated with said one or more job profiles.

7. The system of claim 6, wherein said analysis module comprises a natural language processing module, a data validation module, and an abilities matching module, wherein said candidate profile data is processed through said natural language processing module, said data validation module, and said abilities matching module to identify said abilities data associated with said candidate profile.

8. The system of claim 1, wherein said program instructions of said program application further comprises steps for:
receiving candidate profile data from a candidate, said candidate profile data comprising resume data containing information related to said candidate's work history, education and abilities;
analyzing said candidate profile data through said analysis module to identify abilities data associated with said candidate profile data, said abilities data comprising skills data associated with skills associated with said resume data provided by said candidate;
analyzing said abilities data associated with said candidate profile data to compare said abilities data with abilities data stored in said database module and relating to job positions;
recommending a job position type based on a matching of said abilities data associated said candidate to abilities data associated with said job positions; and
creating a resume specific to said recommended job position type incorporating said abilities data associated with both of said candidate profile data and said job position type.

9. The system of claim 1, further comprising an ability matching module configured for creating abilities data to associate with a candidate profile and abilities data to associate with a job profile, said ability matching module comprising:
an ability creation module configured to creating abilities data for association with a candidate profile or a job profile;
a job ability association and evaluation module configured for associating abilities data with a job profile; and
an ability matching manager module configured for matching abilities data associated with a candidate profile to abilities data associated with a job profile.

10. The system of claim 1, wherein said abilities data comprises skills data, task data and competency data.

11. A method for matching a job position with one or more qualified candidates, said method comprising:
receiving job application data for a job position from an employer, said job application data including a job description, one or more skills and one or more competencies for said job position;
analyzing said job application data by parsing, sorting and validating said job application data and matching said validated data to a set of abilities data in an abilities database to identify abilities data associated with said job position;
creating a job position profile including said job description and said abilities data associated with said job position;
matching said abilities data from said job position profile to abilities data associated with abilities data associated with one or more candidate profiles stored in a candidate database; and
identifying one or more qualified candidates for said job position by identifying matched candidate profiles comprising abilities data that includes at least part of said abilities data associated with said job position profile.

12. The method of claim 10, further comprising the step of:
generating a candidate pool analysis report comprising each candidate identified from said one or more qualified candidates and a fit score for each of said qualified candidates based on the matching of said abilities data.

13. The method of claim 10, further comprising the step of:
generating an individual candidate report for one of said qualified candidates, said individual candidate report comprising said candidate profile of said qualified candidate.

14. The method of claim 10, further comprising the steps of:
receiving candidate profile data from a candidate, said candidate profile data comprising resume data containing information related to said candidate's work history, education and abilities;
analyzing said candidate profile data by parsing, sorting and validating said candidate profile data and matching said validated data to a set of abilities data in an abilities database to identify abilities data associated with said candidate;
creating a candidate profile including said abilities data associated with said candidate; and
storing said candidate profile in said candidate database.

15. The method of claim 10, further comprising the steps of:
creating abilities data for use with said job position profiles, said creation of said abilities data comprising:
receiving task data relating to one or more tasks associated with said job position;
receiving competency data relating to one or more competencies associated with said job position; and
receiving skill data relating to one or more skills associated with said job position.

16. The method of claim 15, wherein the step of matching said abilities data from said job position profile to abilities data associated with abilities data associated with one or more candidate profiles includes associating said abilities data of said candidate profiles with said task data, said receiving data and said skill data of said job position profile abilities data.

17. A method for matching a candidate with one or more job positions based on qualifications of the candidate, said method comprising:
receiving candidate profile data from a candidate, said candidate profile data comprising resume data containing information related to said candidate's work history, education and abilities;
analyzing said candidate profile data by parsing, sorting and validating said candidate profile data and matching said validated data to a set of abilities data in an abilities database to identify abilities data associated with said candidate;
creating a candidate profile including said abilities data associated with said candidate;
matching said abilities data from said candidate profile to abilities data associated with one or more job position profiles stored in a job position database, wherein said job position profiles contain abilities data associated with one or more requirements of a job position; and
identifying one or more job positions for which said candidate is qualified for by identifying matched job position profiles comprising abilities data at least partially included in said abilities data associated with said candidate profile.

18. The method of claim 17, further comprising the step of:
generating a candidate analysis report for said candidate including at least part of said candidate profile and abilities data associated with said candidate.

19. The method of claim 17, further comprising the step of:
generating a candidate assessment report for said candidate including at least one of job positions recommended for said candidate based on a matching of abilities data and abilities data required by said candidate for qualification of one or more job positions.

20. The method of claim 17, further comprising the steps of:
recommending at least one of a job type and a job position based on said identified matched job position profiles; and
generating a resume for said candidate directed to said recommended job type or job position and incorporating said abilities data common between said candidate profile and a job position profile for said recommended job type or position.
